(19) United States
(12) Patent Application Publication
(10) Pub. No.: US 2024/0262960 A1
(43) Pub. Date: Aug. 8, 2024

(54) SPIROBISINDANE POLYMERS OF INTRINSIC MICROPOROSITY AND METHODS OF MAKING

(71) Applicant: Sepion Technologies, Inc., Alameda, CA (US)

(72) Inventors: Steven J. Lyle, Alameda, CA (US); Jessica H. Golden, Alameda, CA (US); Srividya Prasad, Alameda, CA (US); Maria Victoria Cooke, Alameda, CA (US); Adam M. Ozvald, Alameda, CA (US)

(21) Appl. No.: 18/392,739

(22) Filed: Dec. 21, 2023

Related U.S. Application Data
(60) Provisional application No. 63/476,777, filed on Dec. 22, 2022.

(51) Int. Cl. C08G 65/40; B01D 67/00; B01D 69/02; B01D 71/52; B01D 71/82; C08G 65/48; H01M 50/403; H01M 50/414; H01M 50/491

(52) U.S. Cl. CPC C08G 65/4006; B01D 67/00091; B01D 69/02; B01D 71/52; B01D 71/82; C08G 65/48; H01M 50/403; H01M 50/414; H01M 50/491; B01D 2325/02

(57) ABSTRACT

The invention describes spirobisindane polymers of intrinsic microporosity for use as separators in electrochemical cells.

### CROSS-REFERENCES TO RELATED APPLICATIONS

This application claims priority to U.S. Provisional Application No. 63/476,777, filed Dec. 22, 2022, which is incorporated herein in its entirety for all purposes.

### BACKGROUND OF THE INVENTION

Over the past decades, lithium-ion batteries (Li-ion batteries) have developed as the dominant high-energy chemistry due to their uniquely high energy density while maintaining high power and cyclability at acceptable prices. The energy density of current commercial Li-ion battery chemistries is however approaching the technology's theoretical limit, whereas demand for higher energy density batteries at lower unit cost is increasing with the rapid trend towards electrification of the transport and energy industries. There is indeed a need for batteries with improved capacity, long cycle life and high stability. Replacing graphite anodes in Li-ion with lithium metal anodes provides an opportunity to significantly increase the energy density of lithium batteries. However, after repetitive charge-discharge cycles, lithium metal batteries suffer from irreversible capacity loss driven by electrolyte depletion and loss of lithium inventory due to parasitic reactivity between the highly reactive lithium metal anode and the electrolyte components. This process contributes to local non-uniformities in the lithium anode surface, propagating further uneven plating and stripping and resulting in physically isolated “dead” lithium. Further, uneven lithium plating increases the risk of dendrite formation, which can cause thermal runaway resulting in catastrophic cell failure, posing a significant hurdle to the commercialization of lithium metal batteries. Mitigation of dendrite formation in lithium metal batteries is critical to enabling their safe, stable use in commercial applications.

Battery separators are a critical component of Li-ion batteries since they isolate the electrodes, providing ion transport through large pores filled with electrolyte and insulating electronic conductivity that would otherwise induce a short circuit. Whereas separators are not involved directly in cell reactions, their physical properties play an important role in determining the performance of the battery including energy density, power density, and safety. Importantly, separators' mechanical integrity throughout the entire lifetime of the battery cell is critical for prevention of internal short circuit.

Several porous membrane separator materials and composites are currently utilized in Li-ion batteries, such as separators made of polyolefin, for example polyethylene (PE), polypropylene (PP) and polypropylene-polyethylene-polypropylene (PP/PE/PP), as well as ceramic-coated separators, which include PP, PE or multilayer porous substrates with at least one surface coated with a ceramic composite layer. As described in U.S. Pat. No. 6,432,583 (Celgard Inc.), the ceramic composite layer is intended to block dendrite growth and to prevent electronic shorting. Although ceramic coated separators have been successfully utilized in Li-ion batteries to improve mechanical properties, their utility is limited in lithium metal batteries due to parasitic reactions induced at the anode by the binding materials which host the ceramic coatings.

WO 2018/106957 (Sepion Technologies, Inc et al.) describes the application of porous polymers (10-40% porosity, 0.5-2.0 nm pores) as templates that deliver solution-processed precursors of solid-state plus halide containing salts as a conformal coating between the Li-metal surface and the separator surface, in order to increase separator wettability and to increase Li-ion concentration and mobility at the separator-anode interface. The document also describes electrochemical cells including separators comprising several layers: a first polymer layer, comprising a planar species and a linker. The separator may also comprise a porous support made of PP or PE, laminated to the first polymer layer. The separator may also comprise a second membrane layer laminated to the porous support, such second layer comprising a ceramic material.

The use of Polymers of Intrinsic Microporosity (PIMs) as a selective battery membrane has been investigated. PIMs are composed of fused rings providing rigidity and sites of contortion, which may be provided by spiro-centers, by bent or bridged ring moieties, or by similar structural components which serve as a barrier preventing conformational relaxation of polymer chains. PIMs have been described and studied since 2006, as they create continuous networks of interconnected voids used as gas separation membranes, hydrogen storage materials, adsorbents and heterogeneous catalysts. The intrinsic microporosity of PIMs is defined as a continuous network of interconnected intermolecular voids, which form as a direct consequence of the shape and rigidity of the component macromolecules. Notably, the article of Li et al. (Nano Lett. 2015, 15, 5724-5729) describes the use of PIMs as a membrane platform for achieving high-flux, ion-selective transport in nonaqueous electrolytes.

As lithium metal is highly reactive, a solid-electrolyte-interphase (SEI) forms at the interface of the electrode and the adjacent electrolyte-filled separator. The composition and morphology of the SEI impacts the performance of the electrochemical cell. On one hand, the consumption of part of the lithium inventory inherent to the in situ SEI formation process reduces the coulombic efficiency of the electrochemical cell. On the other hand, optimal SEI limits the further decomposition of electrolyte components and improves lithium-ion transport at the electrode-separator interface, improving the cycling performance and service life of the batteries.

Artificial SEI layers have been investigated in order to limit lithium inventory and electrolyte component depletion processes at the surface of anode materials. One of the approaches is based on the use of a layer of PIMs which is coated on porous supports. Notably, WO 2020/037246 A1 (The Regents of the University of California) describes microporous ladder polymer according to the formula -[A-AB—B]— containing amine-functionalized monomer segments, amidoxime functionalized monomer segments, or a combination thereof, such microporous polymers being used in the separator which may comprise one or more support material such as glass fibers. Thin films of microporous polymers on porous supports, such as a polyolefin battery separator (e.g., Celgard) are described in the examples. The article of Chengyin Fu et al. (Nature Materials, April 2020) describes a lithium electrode laminated with a TBAF@PIM-1 coated polyolefin separator, i.e., a separator coated with microporous polymer host (e.g., PIM-1) in combination with tetrabutylammonium fluoride (TBAF), with the separator (Celgard 2325). The coated separator was then assembled in either Li—Li or Li-NMC-622 cells along with a carbonate electrolyte containing an ionizable lithium salt (e.g., LiPF6). The composites are described to act as dendrite-suppressing solid-ion conductors (SICs) in lithium metal batteries.

### BRIEF SUMMARY OF THE INVENTION

In one embodiment, the present invention provides a polymer of Formula I:

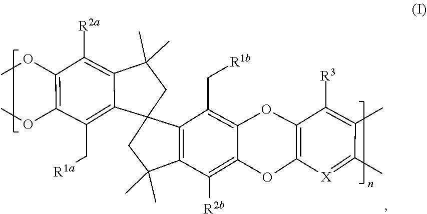

or a salt thereof, wherein:
R^{1a} and R^{1b} are each independently NR^{1a1}R^{1a2}, a 5-10 membered heterocycloalkyl having 1-4 heteroatoms each independently N, O or S, or a 5-10 membered heteroaryl having 1-4 heteroatoms each independently N, O or S, wherein the heterocycloalkyl and heteroaryl are each independently substituted with 0, 1, 2 or 3 R^{1c} groups;
each R^{1a1} and R^{1a2} is independently C₁₋₆ alkyl, C₂₋₆ alkenyl, C₂₋₆ alkynyl, or C₅₋₈ cycloalkenyl;
alternatively, R^{1a1} and R^{1a2} are combined with the atom to which they are attached to form a 5 to 8 membered heterocycloalkenyl having 0 or 1 additional heteroatoms independently N, O, or S;
each R^{1c} is independently C₁₋₆ alkyl, C₂₋₆ alkenyl, C₂₋₆ alkynyl, C₁₋₆ hydroxyalkyl, C₁₋₆ alkoxy, C₂₋₆ alkoxyalkyl, halogen, C₁₋₆ haloalkyl, C₁₋₆ haloalkoxy, ═O, ═NH, —CN, —NO₂, —C(O)H, —C(O)R^{1d}, —C(O)OR^{1d}, —S(O)₂—C₁₋₆ alkyl, —C₁₋₆ alkyl-(SO₃⁻), —O(P═O)(OR^{1d})₂, a 3-10 membered heterocycloalkyl having 1-4 heteroatoms each independently N, O or S, or a 3-10 membered heteroaryl having 1-4 heteroatoms each independently N, O or S, wherein each heterocycloalkyl and heteroaryl is independently substituted with 0, 1, 2, 3, 4, 5 or 6 R^{1e} groups;
R^{1d} is C₁₋₆ alkyl or C₁₋₆ hydroxyalkyl;
each R^{1e} is independently C₁₋₆ alkyl, C₂₋₆ alkenyl, C₂₋₆ alkynyl, C₁₋₆ hydroxyalkyl, C₁₋₆ alkoxy, C₂₋₆ alkoxyalkyl, halogen, C₁₋₆ haloalkyl, C₁₋₆ haloalkoxy, ═CH₂, ═O, ═NH, —CN, or —NO₂;
R^{2a} and R^{2b} are each independently hydrogen or C₁₋₆ alkyl;
R³ is hydrogen, C₁₋₆ alkyl or —CN;
X is —N═ or —C(R⁴)═;
R⁴ is hydrogen, C₁₋₆ alkyl or —CN; and
subscript n is an integer from 10 to 1000,
wherein when R^{2a} and R^{2b} are each hydrogen, R³ is —CN, X is —C(CN)═, and R^{1c} is absent, then R^{1a} and R^{1b} are other than pyrrolidine and morpholine, and
wherein when R^{2a} and R^{2b} are each hydrogen, R³ is —CN, X is —C(CN)═, and R^{1a} and R^{1b} are each piperazine, then R^{1c} is other than —C(O)OR^{1d}.

In another embodiment, the present invention provides a compound of Formula II:

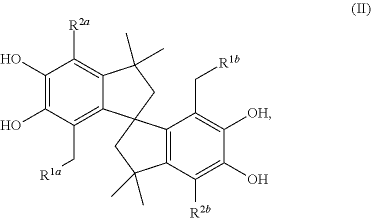

wherein:
R^{1a} and R^{1b} are each independently NR^{1a1}R^{1a2}, a 5-10 membered heterocycloalkyl having 1-4 heteroatoms each independently N, O or S, or a 5-10 membered heteroaryl having 1-4 heteroatoms each independently N, O or S, wherein the heterocycloalkyl and heteroaryl are each independently substituted with 0, 1, 2 or 3 R^{1c} groups;
each R^{1a1} and R^{1a2} is independently C₁₋₆ alkyl, C₂₋₆ alkenyl, C₂₋₆ alkynyl, or C₅₋₈ cycloalkenyl;
alternatively, R^{1a1} and R^{1a2} are combined with the atom to which they are attached to form a 5 to 8 membered heterocycloalkenyl having 0 or 1 additional heteroatoms independently N, O, or S;
each R^{1c} is independently C₁₋₆ alkyl, C₂₋₆ alkenyl, C₂₋₆ alkynyl, C₁₋₆ hydroxyalkyl, C₁₋₆ alkoxy, C₂₋₆ alkoxyalkyl, halogen, C₁₋₆ haloalkyl, C₁₋₆ haloalkoxy, ═O, ═NH, —CN, —NO₂, —C(O)H, —C(O)R^{1d}, —C(O)OR^{1d}, —S(O)₂—C₁₋₆ alkyl, —C₁₋₆ alkyl-(SO₃⁻), —O(P═O)(OR^{1d})₂, a 3-10 membered heterocycloalkyl having 1-4 heteroatoms each independently N, O or S, or a 3-10 membered heteroaryl having 1-4 heteroatoms each independently N, O or S, wherein each heterocycloalkyl and heteroaryl is independently substituted with 0, 1, 2, 3, 4, 5 or 6 R^{1e} groups;
R^{1d} is C₁₋₆ alkyl or C₁₋₆ hydroxyalkyl;
each R^{1e} is independently C₁₋₆ alkyl, C₂₋₆ alkenyl, C₂₋₆ alkynyl, C₁₋₆ hydroxyalkyl, C₁₋₆ alkoxy, C₂₋₆ alkoxyalkyl, halogen, C₁₋₆ haloalkyl, C₁₋₆ haloalkoxy, ═CH₂, ═O, ═NH, —CN, or —NO₂;
R^{2a} and R^{2b} are each independently hydrogen or C₁₋₆ alkyl,
wherein when R^{2a} and R^{2b} are each hydrogen, and R^{1c} is absent, then R^{1a} and R^{1b} are other than pyrrolidine and morpholine, and
wherein when R^{2a} and R^{2b} are each hydrogen, and R^{1a} and R^{1b} are each piperazine, then R^{1c} is other than —C(O)OR^{1d}.

In another embodiment, the present invention provides a method of making a polymer of Formula I:

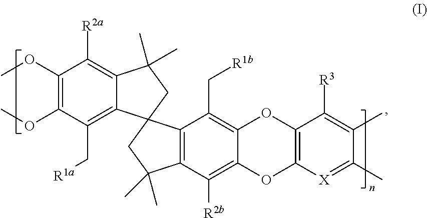

or a salt thereof, comprising:
a) forming a reaction mixture comprising a compound of Formula II:

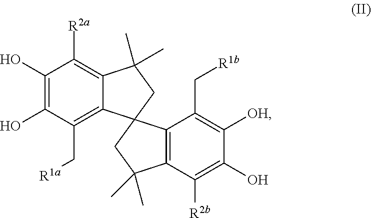

a non-nucleophilic base, a solvent, and a compound of Formula III:

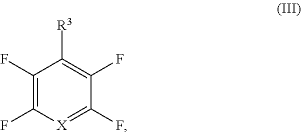

wherein the molar ratio of the compound of Formula II to the compound of Formula III is less than 1.1, under conditions suitable to form the compound of Formula I,
   wherein:
R^{1a} and R^{1b} are each independently NR^{1a1}R^{1a2}, a 5-10 membered heterocycloalkyl having 1-4 heteroatoms each independently N, O or S, or a 5-10 membered heteroaryl having 1-4 heteroatoms each independently N, O or S, wherein the heterocycloalkyl and heteroaryl are each independently substituted with 0, 1, 2 or 3 R^{1c} groups;
each R^{1a1} and R^{1a2} is independently C₁₋₆ alkyl, C₂₋₆ alkenyl, C₂₋₆ alkynyl, or C₅₋₈ cycloalkenyl;
alternatively, R^{1a1} and R^{1a2} are combined with the atom to which they are attached to form a 5 to 8 membered heterocycloalkenyl having 0 or 1 additional heteroatoms independently N, O, or S;
each R^{1c} is independently C₁₋₆ alkyl, C₂₋₆ alkenyl, C₂₋₆ alkynyl, C₁₋₆ hydroxyalkyl, C₁₋₆ alkoxy, C₂₋₆ alkoxyalkyl, halogen, C₁₋₆ haloalkyl, C₁₋₆ haloalkoxy, ═O, ═NH, —CN, —NO₂, —C(O)H, —C(O)R^{1d}, —C(O)OR^{1d}, —S(O)₂—C₁₋₆ alkyl, —C₁₋₆ alkyl-(SO₃⁻), —O(P═O)(OR^{1d})₂, a 3-10 membered heterocycloalkyl having 1-4 heteroatoms each independently N, O or S, or a 3-10 membered heteroaryl having 1-4 heteroatoms each independently N, O or S, wherein each heterocycloalkyl and heteroaryl is independently substituted with 0, 1, 2, 3, 4, 5 or 6 R^{1e} groups;
R^{1d} is C₁₋₆ alkyl or C₁₋₆ hydroxyalkyl;
each R^{1e} is independently C₁₋₆ alkyl, C₂₋₆ alkenyl, C₂₋₆ alkynyl, C₁₋₆ hydroxyalkyl, C₁₋₆ alkoxy, C₂₋₆ alkoxyalkyl, halogen, C₁₋₆ haloalkyl, C₁₋₆ haloalkoxy, ═CH₂, ═O, ═NH, —CN, or —NO₂;
R^{2a} and R^{2b} are each independently hydrogen or C₁₋₆ alkyl;
R³ is hydrogen, C₁₋₆ alkyl or —CN;
X is —N═ or —C(R⁴)═;
R⁴ is hydrogen, C₁₋₆ alkyl or —CN; and
n is an integer from 10 to 1000.

In another embodiment, the present invention provides an electrochemical cell comprising an anode; a cathode; a separator comprising the polymer of Formula I; and an electrolyte.

### DETAILED DESCRIPTION OF THE INVENTION

### I. Definitions

The abbreviations used herein have their conventional meaning within the chemical and biological arts.

Where substituent groups are specified by their conventional chemical formulae, written from left to right, they equally encompass the chemically identical substituents that would result from writing the structure from right to left, e.g., —CH₂O— is equivalent to —OCH₂—.

“Alkyl” refers to a straight or branched, saturated, aliphatic radical having the number of carbon atoms indicated (i.e., C₁₋₆ means one to six carbons). Alkyl can include any number of carbons, such as C₁₋₂, C₁₋₃, C₁₋₄, C₁₋₅, C₁₋₆, C₁₋₇, C₁₋₈, C₁₋₉, C₁₋₁₀, C₂₋₃, C₂₋₄, C₂₋₅, C₂₋₆, C₃₋₄, C₃₋₅, C₃₋₆, C₄₋₅, C₄₋₆ and C₅₋₆. C₁₋₆ alkyl includes, but is not limited to, methyl, ethyl, propyl, isopropyl, butyl, isobutyl, sec-butyl, tert-butyl, pentyl, isopentyl, hexyl, etc.

“Alkenyl” refers to a straight chain or branched hydrocarbon having at least 2 carbon atoms and at least one double bond and having the number of carbon atom indicated (i.e., C₂₋₆ means to two to six carbons). Alkenyl can include any number of carbons, such as C₂, C₂₋₃, C₂₋₄, C₂₋₅, C₂₋₆, C₂₋₇, C₂₋₈, C₂₋₉, C₂₋₁₀, C₃, C₃₋₄, C₃₋₅, C₃₋₆, C₄, C₄₋₅, C₄₋₅, C₅, C₅₋₆, and C₆. Alkenyl groups can have any suitable number of double bonds, including, but not limited to, 1, 2, 3, 4, 5 or more. Examples of C₂₋₄ alkenyl groups include, but are not limited to, vinyl (ethenyl), propenyl, isopropenyl, 1-butenyl, 2-butenyl, isobutenyl, or butadienyl.

“Alkynyl” refers to either a straight chain or branched hydrocarbon having at least 2 carbon atoms and at least one triple bond and having the number of carbon atom indicated (i.e., C₂₋₆ means to two to six carbons). Alkynyl can include any number of carbons, such as C₂, C₂₋₃, C₂₋₄, C₂₋₅, C₂₋₆, C₂₋₇, C₂₋₈, C₂₋₉, C₂₋₁₀, C₃, C₃₋₄, C₃₋₅, C₃₋₆, C₄, C₄₋₅, C₄₋₆, C₅, C₅₋₆, and C₆. Examples of C₂₋₄ alkynyl groups include, but are not limited to, acetylenyl, propynyl, 1-butynyl, 2-butynyl, isobutynyl, sec-butynyl, or butadiynyl.

“Hydroxyalkyl” or “alkylhydroxy” refers to an alkyl group, as defined above, where at least one of the hydrogen atoms is replaced with a hydroxy group. As for the alkyl group, hydroxyalkyl or alkylhydroxy groups can have any suitable number of carbon atoms, such as C₁₋₆. Exemplary C₁₋₄ hydroxyalkyl groups include, but are not limited to, hydroxymethyl, hydroxyethyl (where the hydroxy is in the 1- or 2-position), hydroxypropyl (where the hydroxy is in the 1-, 2- or 3-position), hydroxy butyl (where the hydroxy is in the 1-, 2-, 3- or 4-position), 1,2-dihydroxyethyl, and the like.

“Alkyl-Alkoxy” or “alkoxyalkyl” refers to a radical having an alkyl component and an alkoxy component, where the alkyl component links the alkoxy component to the point of attachment. The alkyl component is as defined above, except that the alkyl component is at least divalent, an alkylene, to link to the alkoxy component and to the point of attachment. The alkyl component can include any number of carbons, such as C₀₋₆, C₁₋₂, C₁₋₃, C₁₋₄, C₁₋₅, C₁₋₆, C₂₋₃, C₂₋₄, C₂₋₅, C₂₋₆, C₃₋₄, C₃₋₅, C₃₋₆, C₄₋₅, C₄₋₆ and C₅₋₆. In some instances, the alkyl component can be absent. The alkoxy component is as defined above. Examples of the alkyl-alkoxy group include, but are not limited to, 2-ethoxy-ethyl and methoxymethyl.

“Halogen” refers to fluorine, chlorine, bromine and iodine.

“Haloalkyl” refers to alkyl, as defined above, where some or all of the hydrogen atoms are replaced with halogen atoms. As for alkyl group, haloalkyl groups can have any suitable number of carbon atoms, such as C₁₋₆. For example, haloalkyl includes trifluoromethyl, fluoromethyl, 2,2,2-trifluoroethyl, etc. In some instances, the term “perfluoro” can be used to define a compound or radical where all the hydrogens are replaced with fluorine. For example, perfluoromethyl refers to 1,1,1-trifluoromethyl.

“Haloalkoxy” refers to an alkoxy group where some or all of the hydrogen atoms are substituted with halogen atoms. As for an alkyl group, haloalkoxy groups can have any suitable number of carbon atoms, such as C₁₋₆. The alkoxy groups can be substituted with 1, 2, 3, or more halogens. When all the hydrogens are replaced with a halogen, for example by fluorine, the compounds are per-substituted, for example, perfluorinated. Haloalkoxy includes, but is not limited to, trifluoromethoxy, 2,2,2,-trifluoroethoxy, perfluoroethoxy, etc.

“Cycloalkyl” refers to a saturated or partially unsaturated, monocyclic, fused bicyclic or bridged polycyclic ring assembly containing from 3 to 12 ring atoms, or the number of atoms indicated. Cycloalkyl can include any number of carbons, such as C₃₋₆, C₄₋₆, C₅₋₆, C₃₋₈, C₄₋₈, C₅₋₈, C₆₋₈, C₃₋₉, C₃₋₁₀, C₃₋₁₁, and C₃₋₁₂. Saturated monocyclic cycloalkyl rings include, for example, cyclopropyl, cyclobutyl, cyclopentyl, cyclohexyl, and cyclooctyl. Saturated bicyclic and polycyclic cycloalkyl rings include, for example, norbornane, [2.2.2] bicyclooctane, decahydronaphthalene and adamantane. Cycloalkyl groups can also be partially unsaturated, having one or more double or triple bonds in the ring. Representative cycloalkyl groups that are partially unsaturated include, but are not limited to, cyclobutene, cyclopentene, cyclohexene, cyclohexadiene (1,3- and 1,4-isomers), cycloheptene, cycloheptadiene, cyclooctene, cyclooctadiene (1,3-, 1,4- and 1,5-isomers), norbornene, and norbornadiene. When cycloalkyl is a saturated monocyclic C₃₋₈ cycloalkyl, exemplary groups include, but are not limited to cyclopropyl, cyclobutyl, cyclopentyl, cyclohexyl, cycloheptyl and cyclooctyl. When cycloalkyl is a saturated monocyclic C₃₋₆ cycloalkyl, exemplary groups include, but are not limited to cyclopropyl, cyclobutyl, cyclopentyl, and cyclohexyl. Cycloalkyl groups can be substituted or unsubstituted.

“Cycloalkenyl” refers to a partially unsaturated, monocyclic, fused bicyclic or bridged polycyclic ring assembly containing from 5 to 12 ring atoms, or the number of atoms indicated. Cycloalkenyl can include any number of carbons, such as C₅₋₆, C₅₋₈, or C₆₋₈. Cycloalkenyl rings having one or more double or triple bonds in the ring include, but are not limited to, cyclopentene, cyclohexene, cyclohexadiene (1,3- and 1,4-isomers), cycloheptene, cycloheptadiene, cyclooctene, cyclooctadiene (1,3-, 1,4- and 1,5-isomers), norbornene, and norbornadiene. Cycloalkenyl groups can be substituted or unsubstituted.

“Heterocycle” or “heterocycloalkyl” refers to a saturated or partially unsaturated ring system (heterocycloalkenyl) having from 3 to 12 ring members and from 1 to 4 heteroatoms of N, O and S. The heteroatoms can also be oxidized, such as, but not limited to, —S(O)— and —S(O)₂—. Heterocycloalkyl groups can include any number of ring atoms, such as, 3 to 6, 4 to 6, 5 to 6, 3 to 8, 4 to 8, 5 to 8, 6 to 8, 3 to 9, 3 to 10, 3 to 11, or 3 to 12 ring members. Any suitable number of heteroatoms can be included in the heterocycloalkyl groups, such as 1, 2, 3, or 4, or 1 to 2, 1 to 3, 1 to 4, 2 to 3, 2 to 4, or 3 to 4. The heterocycloalkyl group can include groups such as aziridine, azetidine, pyrrolidine, piperidine, azepane, azocane, quinuclidine, pyrazolidine, imidazolidine, piperazine (1,2-, 1,3- and 1,4-isomers), oxirane, oxetane, tetrahydrofuran, oxane (tetrahydropyran), oxepane, thiirane, thietane, thiolane (tetrahydrothiophene), thiane (tetrahydrothiopyran), oxazolidine, isoxazolidine, thiazolidine, isothiazolidine, dioxolane, dithiolane, morpholine, thiomorpholine, dioxane, or dithiane. The heterocycloalkyl groups can also be fused to aromatic or non-aromatic ring systems to form members including, but not limited to, indoline. Heterocycloalkyl groups can be unsubstituted or substituted. For example, heterocycloalkyl groups can be substituted with C₁₋₆ alkyl or oxo (═O), among many others.

“Heterocycloalkenyl” refers to a partially unsaturated ring system having from 3 to 12 ring members and from 1 to 4 heteroatoms of N, O and S. Additional heteroatoms can also be useful, including, but not limited to, B, Al, Si and P. The heteroatoms can also be oxidized, such as, but not limited to, —S(O)— and —S(O)₂—. Heterocycloalkenyl groups can include any number of ring atoms, such as, 5 to 8, or 6 to 8. Any suitable number of heteroatoms can be included in the heterocycloalkyl groups, such as 1, 2, 3, or 4, or 1 to 2, 1 to 3, 1 to 4, 2 to 3, 2 to 4, or 3 to 4. The heterocycloalkenyl group can include groups such as 2,5-dihydro-¹H-pyrrole, 1,2,3,6-tetrahydropyridine, 2,3,4,7-tetrahydro-¹H-azepine, 2,7-dihydro-¹H-azepine. Heterocycloalkenyl groups can be unsubstituted or substituted.

“Heteroaryl” refers to a monocyclic or fused bicyclic or tricyclic aromatic ring assembly containing 5 to 16 ring atoms, where from 1 to 5 of the ring atoms are a heteroatom such as N, O or S. The heteroatoms can also be oxidized, such as, but not limited to, N-oxide, —S(O)— and —S(O)₂—. The nitrogen atom(s) can also be quaternized. Heteroaryl groups can include any number of ring atoms, such as, 5 to 6, 5 to 8, 6 to 8, 5 to 9, 5 to 10, 5 to 11, or 5 to 12 ring members. Any suitable number of heteroatoms can be included in the heteroaryl groups, such as 1, 2, 3, 4, or 5, or 1 to 2, 1 to 3, 1 to 4, 1 to 5, 2 to 3, 2 to 4, 2 to 5, 3 to 4, or 3 to 5. Heteroaryl groups can have from 5 to 10 ring members and from 1 to 4 heteroatoms, from 5 to 8 ring members and from 1 to 4 heteroatoms, or from 5 to 8 ring members and from 1 to 3 heteroatoms, or from 5 to 6 ring members and from 1 to 4 heteroatoms, or from 5 to 6 ring members and from 1 to 3 heteroatoms. The heteroaryl group can include groups such as pyrrole, pyridine, imidazole, pyrazole, triazole, tetrazole, pyrazine, pyrimidine, pyridazine, triazine (1,2,3-, 1,2,4- and 1,3,5-isomers), thiophene, furan, thiazole, isothiazole, oxazole, and isoxazole. The heteroaryl groups can also be fused to aromatic ring systems, such as a phenyl ring, to form members including, but not limited to, benzopyrroles such as indole and isoindole, benzopyridines such as quinoline and isoquinoline, benzopyrazine (quinoxaline), benzopyrimidine (quinazoline), benzopyridazines such as phthalazine and cinnoline, benzothiophene, and benzofuran. Other heteroaryl groups include heteroaryl rings linked by a bond, such as bipyridine.

The heteroaryl groups can be linked via any position on the ring. For example, pyrrole includes 1-, 2- and 3-pyrrole, pyridine includes 2-, 3- and 4-pyridine, imidazole includes 1-, 2-, 4- and 5-imidazole, pyrazole includes 1-, 3-, 4- and 5-pyrazole, triazole includes 1-, 4- and 5-triazole, tetrazole includes 1- and 5-tetrazole, pyrimidine includes 2-, 4-, 5- and 6-pyrimidine, pyridazine includes 3- and 4-pyridazine, 1,2,3-triazine includes 4- and 5-triazine, 1,2,4-triazine includes 3-, 5- and 6-triazine, 1,3,5-triazine includes 2-triazine, thiophene includes 2- and 3-thiophene, furan includes 2- and 3-furan, thiazole includes 2-, 4- and 5-thiazole, isothiazole includes 3-, 4- and 5-isothiazole, oxazole includes 2-, 4- and 5-oxazole, isoxazole includes 3-, 4- and 5-isoxazole, indole includes 1-, 2- and 3-indole, isoindole includes 1- and 2-isoindole, quinoline includes 2-, 3- and 4-quinoline, isoquinoline includes 1-, 3- and 4-isoquinoline, quinazoline includes 2- and 4-quinazoline, cinnoline includes 3- and 4-cinnoline, benzothiophene includes 2- and 3-benzothiophene, and benzofuran includes 2- and 3-benzofuran.

Some heteroaryl groups include those having from 5 to 10 ring members and from 1 to 3 ring atoms including N, O or S, such as pyrrole, pyridine, imidazole, pyrazole, triazole, pyrazine, pyrimidine, pyridazine, triazine (1,2,3-, 1,2,4- and 1,3,5-isomers), thiophene, furan, thiazole, isothiazole, oxazole, isoxazole, indole, isoindole, quinoline, isoquinoline, quinoxaline, quinazoline, phthalazine, cinnoline, benzothiophene, and benzofuran. Other heteroaryl groups include those having from 5 to 8 ring members and from 1 to 3 heteroatoms, such as pyrrole, pyridine, imidazole, pyrazole, triazole, pyrazine, pyrimidine, pyridazine, triazine (1,2,3-, 1,2,4- and 1,3,5-isomers), thiophene, furan, thiazole, isothiazole, oxazole, and isoxazole. Some other heteroaryl groups include those having from 9 to 12 ring members and from 1 to 3 heteroatoms, such as indole, isoindole, quinoline, isoquinoline, quinoxaline, quinazoline, phthalazine, cinnoline, benzothiophene, benzofuran and bipyridine. Still other heteroaryl groups include those having from 5 to 6 ring members and from 1 to 2 ring atoms including N, O or S, such as pyrrole, pyridine, imidazole, pyrazole, pyrazine, pyrimidine, pyridazine, thiophene, furan, thiazole, isothiazole, oxazole, and isoxazole.

Some heteroaryl groups include from 5 to 10 ring members and only nitrogen heteroatoms, such as pyrrole, pyridine, imidazole, pyrazole, triazole, pyrazine, pyrimidine, pyridazine, triazine (1,2,3-, 1,2,4- and 1,3,5-isomers), indole, isoindole, quinoline, isoquinoline, quinoxaline, quinazoline, phthalazine, and cinnoline. Other heteroaryl groups include from 5 to 10 ring members and only oxygen heteroatoms, such as furan and benzofuran. Some other heteroaryl groups include from 5 to 10 ring members and only sulfur heteroatoms, such as thiophene and benzothiophene. Still other heteroaryl groups include from 5 to 10 ring members and at least two heteroatoms, such as imidazole, pyrazole, triazole, pyrazine, pyrimidine, pyridazine, triazine (1,2,3-, 1,2,4- and 1,3,5-isomers), thiazole, isothiazole, oxazole, isoxazole, quinoxaline, quinazoline, phthalazine, and cinnoline.

“Salt” refers to acid or base salts of the compounds used in the methods of the present invention. Salts of the basic compounds of the present invention are salts formed with acids, such as mineral acids, organic carboxylic, and organic sulfonic acids. Namely examples of salts include, but are not limited to, halogen salts, such as fluoride, chloride, bromide, and iodide salts, oxoanion salts, such as chlorate, bromate, iodate, carbonate, nitrate, sulfate, or phosphate salts, carboxylic salts, such as fumerate or acetate salts, and sulfonate salts, such as trifluoromethylsulfonate salts.

Also included are base addition salts such as sodium, potassium, calcium, ammonium, organic amino, or magnesium salt, or a similar salt, provided an acidic group constitutes part of the structure. Illustrative examples of salts are mineral acid (hydrochloric acid, hydrobromic acid, phosphoric acid, and the like) salts, organic acid (acetic acid, propionic acid, glutamic acid, citric acid and the like) salts, quaternary ammonium (methyl iodide, ethyl iodide, and the like) salts.

“Sulfonate” refers to a compound comprising —S(O)₃⁻. Examples of sulfonates include, but are not limited to, H₃C—S(O)₃⁻, H₃CCH₂—S(O)₃⁻, or F₃C—S(O)₃⁻. Sulfonates can include any chemical group attached to —S(O)₃⁻ by a single bond.

“Forming a reaction mixture” refers to the process of bringing into contact at least two distinct species such that they mix together and can react. It should be appreciated, however, that the resulting reaction product can be produced directly from a reaction between the added reagents or from an intermediate from one or more of the added reagents which can be produced in the reaction mixture.

“Non-nucleophilic base” refers to a base that is a moderate to strong base but at the same time is a poor nucleophile. Representative non-nucleophilic bases include bases such as sodium carbonate, potassium carbonate, sodium tert-butoxide, potassium tert-butoxide, as well as nitrogen bases, such as trimethylamine, diisopropylethyl amine, N,N-diethylaniline, pyridine, 2,6-lutidine, 2,4,6-collidine, 4-dimethylaminopyridine, and quinuclidine.

“Solvent” refers to a substance, such as a liquid, capable of dissolving a solute. Solvents can be polar or non-polar, protic or aprotic. Polar solvents typically have a dielectric constant greater than about 5 or a dipole moment below about 1.0. Protic solvents are characterized by having a proton available for removal, such as by having a hydroxyl or carboxy group. Aprotic solvents lack such a group. Representative polar protic solvents include alcohols (methanol, ethanol, propanol, isopropanol, etc.), acids (formic acid, acetic acid, etc.) and water. Representative polar aprotic solvents include dichloromethane, chloroform, tetrahydrofuran, diethyl ether, acetone, ethyl acetate, dimethylformamide, dimethylacetamide, acetonitrile, and dimethyl sulfoxide. Representative non-polar solvents include alkanes (pentanes, hexanes, etc.), benzene, toluene, and 1,4-dioxane. Other solvents are useful in the present invention.

“Electrode” refers to an electrically conductive material in a circuit that is in contact with a nonmetallic part of the circuit, such as the electrolyte. The electrode can be a positive electrode or cathode, the electrode where reduction occurs. The electrode can be a negative electrode or anode, the electrode where oxidation occurs.

“Anode” refers to a negative electrode, as described above.

“Cathode” refers to a positive electrode, as described above.

“Electrolyte” refers to a solution of the electrochemical cell that includes ions, such as metal ions and protons as well as anions, that provides ionic communication between the positive and negative electrodes.

“Electrolyte Solvent” refers to the molecules solvating ions in the liquid electrolyte, such as small organic carbonates or ethereal molecules, that enable diffusion of ions in the electrolyte. The Electrolyte Solvent may also be an ionic liquid or a gas at standard temperature and pressure.

“Separator” refers to an electrically insulating membrane between the positive and negative electrodes to prevent electrical shorts, i.e., provides electronic isolation. The separator also allows the ions to move between the positive and anode electrodes. The separator can include any suitable polymeric or inorganic material that is electrically insulating. The separator can include several layers including one or more membrane layers, and a porous support material for the membrane layers.

“First polymer layer” refers to a layer of the separator that is permeable to a first species of the electrolyte while substantially impermeable to liquid electrolyte. The membrane layer can be of any suitable material that can provide the selective permeability, such as composites of microporous polymers and inorganic materials. “Substantially impermeable” refers to less than 10% of the electrolyte solvent passing through the membrane layer, or less than 1%, or less than 0.1%, or less than 0.01%, or less than 0.001% of the liquid electrolyte passing through the membrane layer.

“Oxide” refers to a chemical compound having an oxygen, such as metal oxides or molecular oxides.

“Pore size” or “pore diameter” refers to the average diameter of interstitial space not occupied by the pore forming material. This may include, but is not limited to, the space remaining between polymer chains due to inefficient packing, the space remaining between organic linkers and metal ions in a metal-organic framework, the space between layers and within the holes of stacked 2D material, and the space left in an amorphous or semi-crystalline carbon due to unaligned covalent bonding. The pore size may also change once wetted with electrolyte or it may stay the same.

“Surface area” refers to the surface area of a porous material as measured by a variety of methods, such as nitrogen adsorption BET.

“Microporous polymer” refers to an amorphous glassy polymer having interconnected pores with an average diameter of less than 10 nm, or less than 5, 4, 3, 2, or less than 1 nm.

“Microporosity” refers to a layer of the membrane comprising pores of less than or equal to 2 nm in size.

“Intrinsic microporosity.” refers to a polymer providing a continuous network of interconnected intermolecular voids (suitably of less than or equal to 4 nm in size), which forms as a direct consequence of the shape and rigidity of at least a proportion of the component monomers of the polymer. As will be appreciated by a person skilled in the art, intrinsic microporosity arises due to the structure of the monomers used to form the polymer and, as the term suggests, it is an intrinsic property of a polymer formed from such monomers.

It is understood that the network polymers disclosed herein have a certain property (i.e. intrinsic microporosity). Disclosed herein are certain structural requirements in the monomers used for giving a polymer performing the disclosed function, and it is understood that there are a variety of structures that can perform the same function that are related to the disclosed monomer structures, and that these structures will typically achieve the same result.

“Molecular weight” refers to the molecular weight of the polymer as determined by Size Exclusion Chromatograph (SEC), laser-light scattering, MALDI-TOF, or other methods. The molecular weight can be measured by the weight average or the number average. “Number average molecular weight” (M_{N}) refers to the mole fraction of molecules in the polymer sample, i.e., the total weight of polymer divided by the total number of molecules, or the arithmetic mean. “Weight average molecular weight” (M_{W}) refers to the weight fraction of molecules in the polymer sample, emphasizing the weight of the individual molecules such that the M_{W} is greater than the M_{N}. The ratio of the M_{W}/M_{N}, the polydispersity index, represents the distribution of molecular weights in the polymer.

“Metal” refers to elements of the periodic table that are metallic and that can be neutral, or negatively or positively charged as a result of having more or fewer electrons in the valence shell than is present for the neutral metallic element. Metals useful in the present invention include the alkali metals, alkali earth metals, transition metals and post-transition metals. Alkali metals include Li, Na, K, Rb and Cs. Alkaline earth metals include Be, Mg, Ca, Sr and Ba. Transition metals include Sc, Ti, V, Cr, Mn, Fe, Co, Ni, Cu, Zn, Y, Zr, Nb, Mo, Tc, Ru, Rh, Pd, Ag, Cd, La, Hf, Ta, W, Re, Os, Ir, Pt, Au, Hg and Ac. Post-transition metals include Al, Ga, In, Tl, Ge, Sn, Pb, Sb, Bi, and Po. Rare earth metals include Sc, Y, La Ce, Pr, Nd, Sm, Eu, Gd, Tb, Dy, Ho, Er, Tm, Yb and Lu. One of skill in the art will appreciate that the metals described above can each adopt several different oxidation states, all of which are useful in the present invention. In some instances, the most stable oxidation state is formed, but other oxidation states are useful in the present invention.

“Porous support” refers to any suitable material that is capable of supporting the membrane layer of the present invention, and is permeable to the electrolyte.

“Laminated” refers to the deposition of one layer on another, such as the microporous polymer layer or first polymer layer onto the porous support.

### II. Spirobisindane Polymers

The present invention provides a polymer of Formula I or a salt thereof. In some embodiments, the present invention provides a polymer of Formula I:

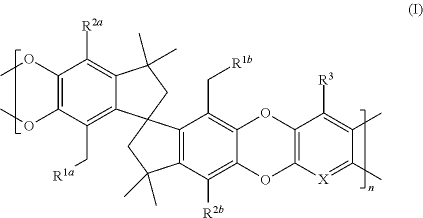

or a salt thereof, wherein:
R^{1a} and R^{1b} are each independently NR^{1a1}R^{1a2}, a 5-10 membered heterocycloalkyl having 1-4 heteroatoms each independently N, O or S, or a 5-10 membered heteroaryl having 1-4 heteroatoms each independently N, O or S, wherein the heterocycloalkyl and heteroaryl are each independently substituted with 0, 1, 2 or 3 R^{1c} groups;
each R^{1a1} and R^{1a2} is independently C₁₋₆ alkyl, C₂₋₆ alkenyl, C₂₋₆ alkynyl, or C₅₋₈ cycloalkenyl;
alternatively, R^{1a1} and R^{1a2} are combined with the atom to which they are attached to form a 5 to 8 membered heterocycloalkenyl having 0 or 1 additional heteroatoms independently N, O, or S;
each R^{1c} is independently C₁₋₆ alkyl, C₂₋₆ alkenyl, C₂₋₆ alkynyl, C₁₋₆ hydroxyalkyl, C₁₋₆ alkoxy, C₂₋₆ alkoxyalkyl, halogen, C₁₋₆ haloalkyl, C₁₋₆ haloalkoxy, ═O, ═NH, —CN, —NO₂, —C(O)H, —C(O)R^{1d}, —C(O)OR^{1d}, —S(O)₂—C₁₋₆ alkyl, —C₁₋₆ alkyl-(SO₃⁻), —O(P═O)(OR^{1d})₂, a 3-10 membered heterocycloalkyl having 1-4 heteroatoms each independently N, O or S, or a 3-10 membered heteroaryl having 1-4 heteroatoms each independently N, O or S, wherein each heterocycloalkyl and heteroaryl is independently substituted with 0, 1, 2, 3, 4, 5 or 6 R^{1e} groups;
R^{1d} is C₁₋₆ alkyl or C₁₋₆ hydroxyalkyl;
each R^{1e} is independently C₁₋₆ alkyl, C₂₋₆ alkenyl, C₂₋₆ alkynyl, C₁₋₆ hydroxyalkyl, C₁₋₆ alkoxy, C₂₋₆ alkoxyalkyl, halogen, C₁₋₆ haloalkyl, C₁₋₆ haloalkoxy, ═CH₂, ═O, ═NH, —CN, or —NO₂;
R^{2a} and R^{2b} are each independently hydrogen or C₁₋₆ alkyl;
R³ is hydrogen, C₁₋₆ alkyl or —CN;
X is —N═ or —C(R⁴)═;
R⁴ is hydrogen, C₁₋₆ alkyl or —CN; and
subscript n is an integer from 10 to 1000,
wherein when R^{2a} and R^{2b} are each hydrogen, R³ is —CN, X is —C(CN)═, and R^{1c} is absent, then R^{1a} and R^{1b} are other than pyrrolidine and morpholine, and
wherein when R^{2a} and R^{2b} are each hydrogen, R³ is —CN, X is —C(CN)—, and R^{1a} and R^{1b} are each piperazine, then R^{1c} is other than —C(O)OR^{1d}.

In some embodiments, the present invention provides a polymer of Formula I:

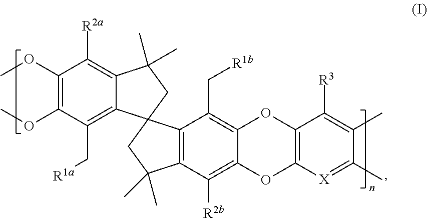

or a salt thereof, wherein:
R^{1a} and R^{1b} are each independently a 5-10 membered heterocycloalkyl having 1-4 heteroatoms each independently N, O or S, or a 5-10 membered heteroaryl having 1-4 heteroatoms each independently N, O or S, wherein the heterocycloalkyl and heteroaryl are each independently substituted with 0, 1, 2 or 3 R^{1c} groups;
each R^{1c} is independently C₁₋₆ alkyl, C₂₋₆ alkenyl, C₂₋₆ alkynyl, halogen, C₁₋₆ haloalkyl, ═O, ═NH, —CN, —NO₂, —C(O)H, —C(O)R^{1d}, —C(O)OR^{1d}, —S(O)₂—C₁₋₆ alkyl, —C₁₋₆ alkyl-(SO₃⁻), —O(P═O)(OR^{1d})₂, a 3-10 membered heterocycloalkyl having 1-4 heteroatoms each independently N, O or S, or a 3-10 membered heteroaryl having 1-4 heteroatoms each independently N, O or S;
R^{1d} is C₁₋₆ alkyl or C₁₋₆ hydroxyalkyl;
R^{2a} and R^{2b} are each independently hydrogen or C₁₋₆ alkyl;
R³ is hydrogen, C₁₋₆ alkyl or —CN;
X is —N═ or —C(R⁴)═;
R⁴ is hydrogen, C₁₋₆ alkyl or —CN; and subscript n is an integer from 10 to 1000,
wherein when R^{2a} and R^{2b} are each hydrogen, R³ is —CN, X is —C(CN)═, and R^{1c} is absent, then R^{1a} and R^{1b} are other than pyrrolidine and morpholine, and
wherein when R^{2a} and R^{2b} are each hydrogen, R³ is —CN, X is —C(CN)═, and R^{1a} and R^{1b} are each piperazine, then R^{1c} is other than —C(O)OR^{1d}.

In some embodiments, the polymer of Formula I, or a salt thereof, is the polymer wherein R^{1a} and R^{1b} are each independently a 5-10 membered heterocycloalkyl having 2-4 heteroatoms each independently N or S, or a 5-10 membered heteroaryl having 1-4 heteroatoms each independently N, O or S, wherein the heterocycloalkyl and heteroaryl are each independently substituted with 0, 1, 2 or 3 R^{1c} groups; and each R^{1c} is independently C₁₋₆ alkyl, C₂₋₆ alkenyl, C₂₋₆ alkynyl, halogen, C₁₋₆ haloalkyl, ═O, ═NH, —CN, —NO₂, —C(O)H, —C(O)R^{1d}, —C(O)OR^{1d}, —S(O)₂—C₁₋₆ alkyl, —C₁₋₆ alkyl-(SO₃⁻), —O(P═O)(OR^{1d})₂, a 3-10 membered heterocycloalkyl having 1-4 heteroatoms each independently N, O or S, or a 3-10 membered heteroaryl having 1-4 heteroatoms each independently N, O or S.

In some embodiments, the polymer of Formula I, or a salt thereof, is the polymer wherein R^{1a} and R^{1b} are each independently a 5-10 membered heterocycloalkyl having 1-4 heteroatoms each independently N, O or S, wherein each heterocycloalkyl is independently substituted with 0, 1, 2 or 3 R^{1c} groups; and each R^{1c} is independently C₁₋₆ alkyl, ═O, —S(O)₂—C₁₋₆ alkyl, or a 3-6 membered heterocycloalkyl having 1-2 heteroatoms each independently N, O or S.

In some embodiments, the polymer of Formula I, or a salt thereof, is the polymer wherein R^{1a} and R^{1b} are each a 5-10 membered heterocycloalkyl having 1-4 heteroatoms each independently N, O or S, wherein the heterocycloalkyl is substituted with 0, 1, 2 or 3 R^{1c} groups; and each R^{1c} is independently C₁₋₆ alkyl, ═O, —S(O)₂—C₁₋₆ alkyl, or a 3-6 membered heterocycloalkyl having 1-2 heteroatoms each independently N, O or S.

In some embodiments, the polymer of Formula I, or a salt thereof, is the polymer wherein R^{1a} and R^{1b} are each independently a 5-6 membered heterocycloalkyl having 1-3 heteroatoms each independently N, O or S, wherein each heterocycloalkyl is independently substituted with 0, 1, 2 or 3 R^{1c} groups; and each R^{1c} is independently C₁₋₃ alkyl, ═O, —S(O)₂—C₁₋₃ alkyl, or a 5-6 membered heterocycloalkyl having 1-2 heteroatoms each independently N, O or S.

In some embodiments, the polymer of Formula I, or a salt thereof, is the polymer wherein R^{1a} and R^{1b} are each a 5-6 membered heterocycloalkyl having 1-3 heteroatoms each independently N, O or S, wherein the heterocycloalkyl is substituted with 0, 1, 2 or 3 R^{1c} groups; and each R^{1c} is independently C₁₋₃ alkyl, ═O, —S(O)₂—C₁₋₃ alkyl, or a 5-6 membered heterocycloalkyl having 1-2 heteroatoms each independently N, O or S.

In some embodiments, the polymer of Formula I, or a salt thereof, is the polymer wherein R^{1a} and R^{1b} are each a 5-6 membered heterocycloalkyl having 2-3 heteroatoms each independently N, or S, wherein the heterocycloalkyl is substituted with 0, 1, 2 or 3 R^{1c} groups; and each R^{1c} is independently C₁₋₃ alkyl, ═O, —S(O)₂—C₁₋₃ alkyl, or a 5-6 membered heterocycloalkyl having 1-2 heteroatoms each independently N, O or S.

In some embodiments, the polymer of Formula I, or a salt thereof, is the polymer wherein R^{1a} and R^{1b} are each independently pyrrolidine, piperidine, diazinane, triazinane, morpholine, or thiomorpholine, wherein each is independently substituted with 0, 1, 2 or 3 R^{1c} groups; and each R^{1c} is independently methyl, ═O, —SO₂—C₁₋₃ alkyl, tetrahydropyran, pyrrolidine, piperidine, diazinane, thiolane, thiane, or morpholine.

In some embodiments, the polymer of Formula I, or a salt thereof, is the polymer wherein R^{1a} and R^{1b} are each pyrrolidine, piperidine, diazinane, triazinane, morpholine, or thiomorpholine, wherein each is independently substituted with 0, 1, 2 or 3 R^{1c} groups; and each R^{1c} is independently methyl, ═O, —SO₂—C₁₋₃ alkyl, tetrahydropyran, pyrrolidine, piperidine, diazinane, thiolane, thiane, or morpholine.

In some embodiments, the polymer of Formula I, or a salt thereof, is the polymer wherein R^{1a} and R^{1b} are each independently:

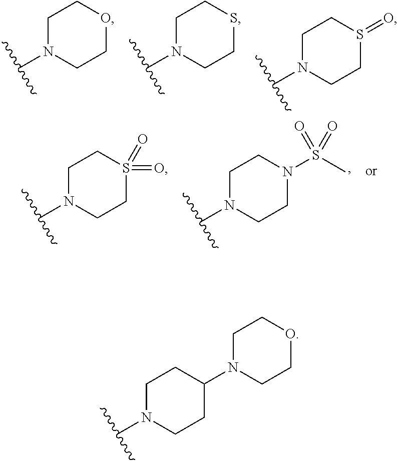

In some embodiments, the polymer of Formula I, or a salt thereof, is the polymer wherein R^{1a} and R^{1b} are each independently:

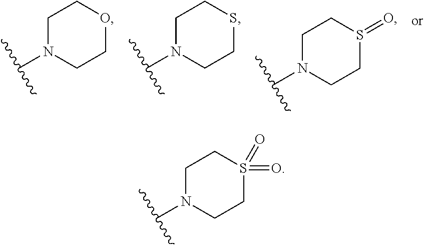

In some embodiments, the polymer of Formula I, or a salt thereof, is the polymer wherein R^{1a} and R^{1b} are each independently NR^{1a1}R^{1a2}; and each R^{1a1} and R^{1a2} is independently C₁₋₃ alkyl, C₂₋₄ alkenyl, or C₂₋₄ alkynyl. In some embodiments, the polymer of Formula I, or a salt thereof, is the polymer wherein R^{1a} and R^{1b} are each independently NR^{1a1}R^{1a2}; and each R^{1a1} and R^{1a2} is independently C₁₋₃ alkyl, or C₂₋₄ alkenyl. In some embodiments, the polymer of Formula I, or a salt thereof, is the polymer wherein R^{1a} and R^{1b} are each independently NR^{1a1}R^{1b1}; and each R^{1a1} and R^{1a2} is independently methyl, ethyl, propyl, isopropyl, ethenyl, 1-propenyl, 2-propenyl, isopropenyl, 1-butenyl, 2-butenyl, 3-butenyl, isobutenyl, ethynyl, 1-propynyl, 2-propynyl, isopropynyl, 1-butynyl, 2-butynyl, and 3-butynyl. In some embodiments, the polymer of Formula I, or a salt thereof, is the polymer wherein R^{1a} and R^{1b} are each independently NR^{1a1}R^{1b1}; and each R^{1a1} and R^{1a2} is independently methyl, ethyl, propyl, isopropyl, ethenyl, 1-propenyl, 2-propenyl, isopropenyl, 1-butenyl, 2-butenyl, 3-butenyl, or isobutenyl.

In some embodiments, the polymer of Formula I, or a salt thereof, is the polymer wherein R^{1a} and R^{1b} are each independently

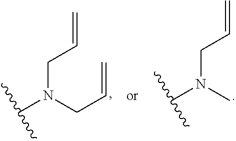

In some embodiments, the polymer of Formula I, or a salt thereof, is the polymer wherein R^{1a} and R^{1b} are each independently

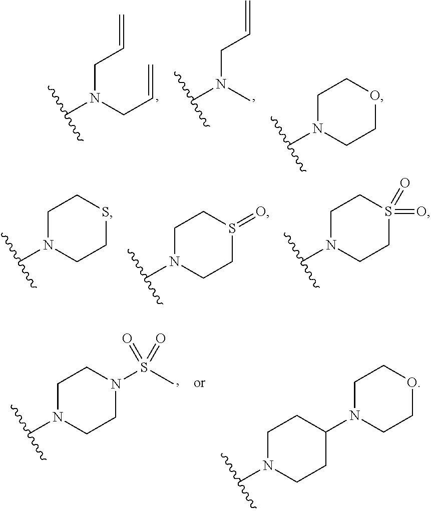

In some embodiments, the polymer of Formula I, or a salt thereof, is the polymer wherein R^{2a} and R^{2b} are each hydrogen.

In some embodiments, the polymer of Formula I, or a salt thereof, is the polymer wherein R³ is hydrogen, C₁₋₃ alkyl or —CN. In some embodiments, the polymer of Formula I, or a salt thereof, is the polymer wherein R³ is —CN.

In some embodiments, the polymer of Formula I, or a salt thereof, is the polymer wherein X is —N═. In some embodiments, the polymer of Formula I, or a salt thereof, is the polymer wherein X is —C(R⁴); and R⁴ is hydrogen, C₁₋₆ alkyl or —CN.

In some embodiments, the polymer of Formula I, or a salt thereof, is the polymer wherein R⁴ is —CN.

In some embodiments, the polymer of Formula I, or a salt thereof, is the polymer wherein the salt comprises an anion that is a tetrafluoroborate, bis(oxalato)borate, difluoro(oxalato)borate, trifluorocyanoborate, cyano tris(2,2,2-trifluoroethyl) borate, carbonate, bicarbonate, carboxylate, acetate, trifluoroacetate, dicarboxylate, bis(fluorosulfonyl)imide, bis(trifluoromethanesulfonyl)imide, thiocyanate, nitrite, nitrate, hexafluorosilicate, phosphite, phosphate, difluorophosphate, hexafluorophosphate, hydrogen phosphate, dihydrogen phosphate, tetrafluoro oxalato phosphate, difluoro(bisoxalato) phosphate, phosphonate, sulfite, bisulfite, sulfate, bisulfate, thiosulfate, sulfonate, trifluoromethanesulfonate, p-toluenesulfonate, halide, hypochlorite, chlorite, chlorate, perchlorate, bromate, iodate, chromate, dichromate, or permanganate. In some embodiments, the polymer of Formula I, or a salt thereof, is the polymer wherein the salt comprises an anion that is a sulfonate. In some embodiments, the polymer of Formula I, or a salt thereof, is the polymer wherein the salt comprises an anion that is:

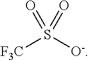

In some embodiments, the polymer of Formula I, or a salt thereof, is the polymer wherein the salt comprises a cation that is

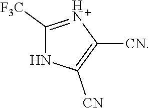

In some embodiments, the polymer of Formula I, or a salt thereof, is the polymer wherein:
R^{1a} and R^{1b} are each independently NR^{1a1}R^{1a2}, a 5-10 membered heterocycloalkyl having 2-4 heteroatoms each independently N or S, or a 5-10 membered heteroaryl having 1-4 heteroatoms each independently N, O or S, wherein the heterocycloalkyl and heteroaryl are each independently substituted with 0, 1, 2 or 3 R^{1c} groups;
each R^{1a1} and R^{1a2} is independently C₁₋₆ alkyl, C₂₋₆ alkenyl, C₂₋₆ alkynyl, or C₅₋₈ cycloalkenyl;
each R^{1c} is independently C₁₋₆ alkyl, C₂₋₆ alkenyl, C₂₋₆ alkynyl, halogen, C₁₋₆ haloalkyl, ═O, ═NH, —CN, —NO₂, —C(O)H, —C(O)R^{1d}, —C(O)OR^{1d}, —S(O)₂—C₁₋₆ alkyl, —C₁₋₆ alkyl-(SO₃⁻), —O(P═O)(OR^{1d})₂, a 3-10 membered heterocycloalkyl having 1-4 heteroatoms each independently N, O or S, or a 3-10 membered heteroaryl having 1-4 heteroatoms each independently N, O or S;
X is —N═ or —C(R⁴)═; and
R⁴ is hydrogen, C₁₋₆ alkyl or —CN,
wherein when X is —C(CN)═, then R^{1a} and R^{1b} are each other than morpholine.

In some embodiments, the polymer of Formula I, or a salt thereof, is the polymer wherein:
R^{1a} and R^{1b} are each independently a 5-10 membered heterocycloalkyl having 2-4 heteroatoms each independently N or S, or a 5-10 membered heteroaryl having 1-4 heteroatoms each independently N, O or S, wherein the heterocycloalkyl and heteroaryl are each independently substituted with 0, 1, 2 or 3 R^{1c} groups;
each R^{1c} is independently C₁₋₆ alkyl, C₂₋₆ alkenyl, C₂₋₆ alkynyl, halogen, C₁₋₆ haloalkyl, ═O, ═NH, —CN, —NO₂, —C(O)H, —C(O)R^{1d}, —C(O)OR^{1d}, —S(O)₂—C₁₋₆ alkyl, —C₁₋₆ alkyl-(SO₃⁻), —O(P═O)(OR^{1d})₂, a 3-10 membered heterocycloalkyl having 1-4 heteroatoms each independently N, O or S, or a 3-10 membered heteroaryl having 1-4 heteroatoms each independently N, O or S;
X is —N═ or —C(R⁴)═; and
R⁴ is hydrogen, C₁₋₆ alkyl or —CN.

In some embodiments, the polymer of Formula I, or a salt thereof, is the polymer wherein:
R^{1a} and R^{1b} are each independently a 5-10 membered heterocycloalkyl having 1-4 heteroatoms each independently N, O or S, or a 5-10 membered heteroaryl having 1-4 heteroatoms each independently N, O or S, wherein the heterocycloalkyl and heteroaryl are each independently substituted with 0, 1, 2 or 3 R^{1c} groups;
each R^{1c} is independently C₁₋₆ alkyl, C₂₋₆ alkenyl, C₂₋₆ alkynyl, halogen, C₁₋₆ haloalkyl, ═O, ═NH, —CN, —NO₂, —C(O)H, —C(O)R^{1d}, —C(O)OR^{1d}, —S(O)₂—C₁₋₆ alkyl, —C₁₋₆ alkyl-(SO₃⁻), —O(P═O)(OR^{1d})₂, a 3-10 membered heterocycloalkyl having 1-4 heteroatoms each independently N, O or S, or a 3-10 membered heteroaryl having 1-4 heteroatoms each independently N, O or S; and
X is —N═.

In some embodiments, the polymer of Formula I, or a salt thereof, is the polymer wherein:
R^{1a} and R^{1b} are each independently NR^{1a1}R^{1a2}, a 5-10 membered heterocycloalkyl having 1-4 heteroatoms each independently N or S, or a 5-10 membered heteroaryl having 1-4 heteroatoms each independently N, O or S, wherein the heterocycloalkyl and heteroaryl are each independently substituted with 0, 1, 2 or 3 R^{1c} groups;
each R^{1a1} and R^{1a2} is independently C₁₋₆ alkyl, C₂₋₆ alkenyl, C₂₋₆ alkynyl, or C₅₋₈ cycloalkenyl;
each R^{1c} is independently C₁₋₆ alkyl, C₂₋₆ alkenyl, C₂₋₆ alkynyl, halogen, C₁₋₆ haloalkyl, ═O, ═NH, —CN, —NO₂, —C(O)H, —C(O)R^{1d}, —C(O)OR^{1d}, —S(O)₂—C₁₋₆ alkyl, —C₁₋₆ alkyl-(SO₃⁻), —O(P═O)(OR^{1d})₂, a 3-10 membered heterocycloalkyl having 1-4 heteroatoms each independently N, O or S, or a 3-10 membered heteroaryl having 1-4 heteroatoms each independently N, O or S;
X is —C(R⁴)═; and
R⁴ is hydrogen, C₁₋₆ alkyl or —CN,
wherein when X is —C(CN)═, then R^{1a} and R^{1b} are each other than morpholine.

In some embodiments, the polymer of Formula I, or a salt thereof, is the polymer wherein:
R^{1a} and R^{1b} are each independently a 5-10 membered heterocycloalkyl having 1-4 heteroatoms each independently N or S, or a 5-10 membered heteroaryl having 1-4 heteroatoms each independently N, O or S, wherein the heterocycloalkyl and heteroaryl are each independently substituted with 0, 1, 2 or 3 R^{1c} groups;
each R^{1c} is independently C₁₋₆ alkyl, C₂₋₆ alkenyl, C₂₋₆ alkynyl, halogen, C₁₋₆ haloalkyl, ═O, ═NH, —CN, —NO₂, —C(O)H, —C(O)R^{1d}, —C(O)OR^{1d}, —S(O)₂—C₁₋₆ alkyl, —C₁₋₆ alkyl-(SO₃⁻), —O(P═O)(OR^{1d})₂, a 3-10 membered heterocycloalkyl having 1-4 heteroatoms each independently N, O or S, or a 3-10 membered heteroaryl having 1-4 heteroatoms each independently N, O or S;
X is —C(R⁴)═; and
R⁴ is hydrogen, C₁₋₆ alkyl or —CN.

In some embodiments, the polymer of Formula I, or a salt thereof, is the polymer ]wherein:
R^{1a} and R^{1b} are each independently NR^{1a1}R^{1a2}, a 5-6 membered heterocycloalkyl having 1-3 heteroatoms each independently N, O or S, wherein each heterocycloalkyl is independently substituted with 0, 1, 2 or 3 R^{1c} groups;
each R^{1a1} and R^{1a2} is independently C₁₋₃ alkyl, or C₂₋₄ alkenyl;
each R^{1c} is independently C₁₋₃ alkyl, ═O, —C₁₋₃ alkyl-(SO₃⁻), or a 5-6 membered heterocycloalkyl having 1-2 heteroatoms each independently N, O or S;
R^{2a} and R^{2b} are each hydrogen;
R³ is —CN; and
X is —N═ or —C(CN)═,
wherein when X is —C(CN)═, then R^{1a} and R^{1b} are each other than morpholine.

In some embodiments, the polymer of Formula I, or a salt thereof, is the polymer wherein:
R^{1a} and R^{1b} are each independently a 5-6 membered heterocycloalkyl having 1-3 heteroatoms each independently N, O or S, wherein each heterocycloalkyl is independently substituted with 0, 1, 2 or 3 R^{1c} groups;
each R^{1c} is independently C₁₋₃ alkyl, ═O, —C₁₋₃ alkyl-(SO₃⁻), or a 5-6 membered heterocycloalkyl having 1-2 heteroatoms each independently N, O or S;
R^{2a} and R^{2b} are each hydrogen;
R³ is —CN; and
X is —N═ or —C(CN)═,
wherein when X is —C(CN)—, then R^{1a} and R^{1b} are each other than morpholine.

In some embodiments, the polymer of Formula I, or a salt thereof, is the polymer wherein:
R^{1a} and R^{1b} are each independently a 5-6 membered heterocycloalkyl having 1-3 heteroatoms each independently N, O or S, wherein each heterocycloalkyl is independently substituted with 0, 1, 2 or 3 R^{1c} groups;
each R^{1c} is independently C₁₋₃ alkyl, ═O, —C₁₋₃ alkyl-(SO₃⁻), or a 5-6 membered heterocycloalkyl having 1-2 heteroatoms each independently N, O or S;
R^{2a} and R^{2b} are each hydrogen;
R³ is —CN; and
X is —N═.

In some embodiments, the polymer of Formula I, or a salt thereof, is the polymer wherein:
R^{1a} and R^{1b} are each independently

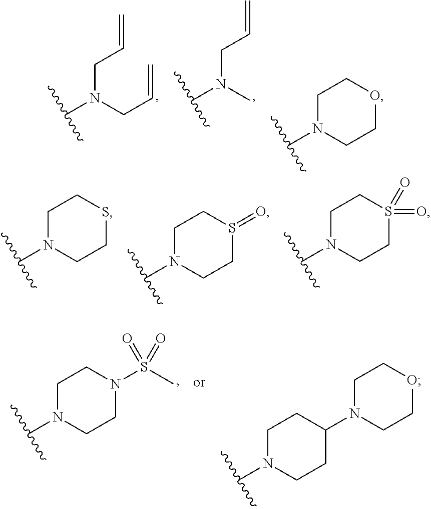

R^{2a} and R^{2b} are each hydrogen;
R³ is —CN; and
X is —N═ or —C(CN)═,
wherein when X is —C(CN)═, then R^{1a} and R^{1b} are each other than morpholine.

In some embodiments, the polymer of Formula I, or a salt thereof, is the polymer wherein:
R^{1a} and R^{1b} are each independently

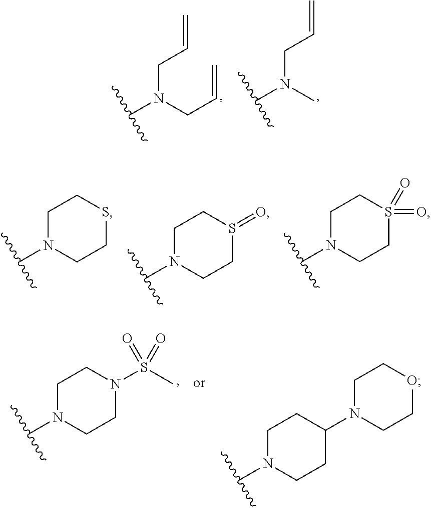

R^{2a} and R^{2b} are each hydrogen;
R³ is —CN; and
X is —C(CN)═.

In some embodiments, the polymer of Formula I, or a salt thereof, is the polymer wherein:
R^{1a} and R^{1b} are each

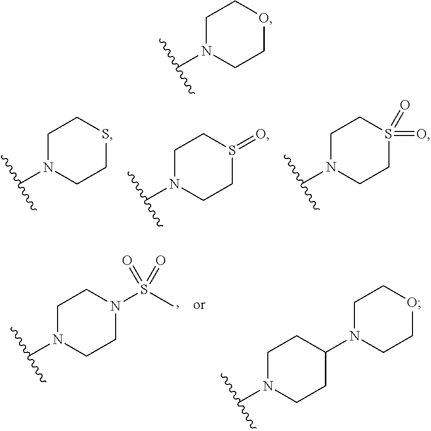 [SMILES: *N1CCOCC1 ; *N1CCSCC1 ; *N1CCS(=O)CC1 ; *N1CCS(=O)(=O)CC1 ; *N1CCN(S(C)(=O)=O)CC1 ; *N1CCC(N2CCOCC2)CC1]

R^{2a} and R^{2b} are each hydrogen;
R³ is —CN; and
X is —N═ or —C(CN)═,
wherein when X is —C(CN)═, then R^{1a} and R^{1b} are each other than morpholine.

In some embodiments, the polymer of Formula I, or a salt thereof, is the polymer:

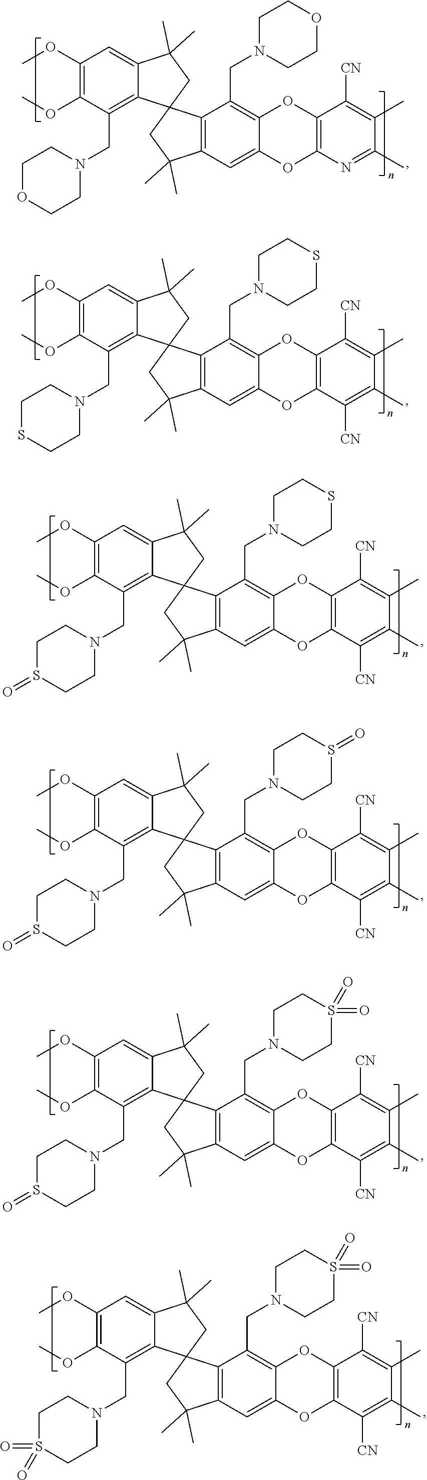

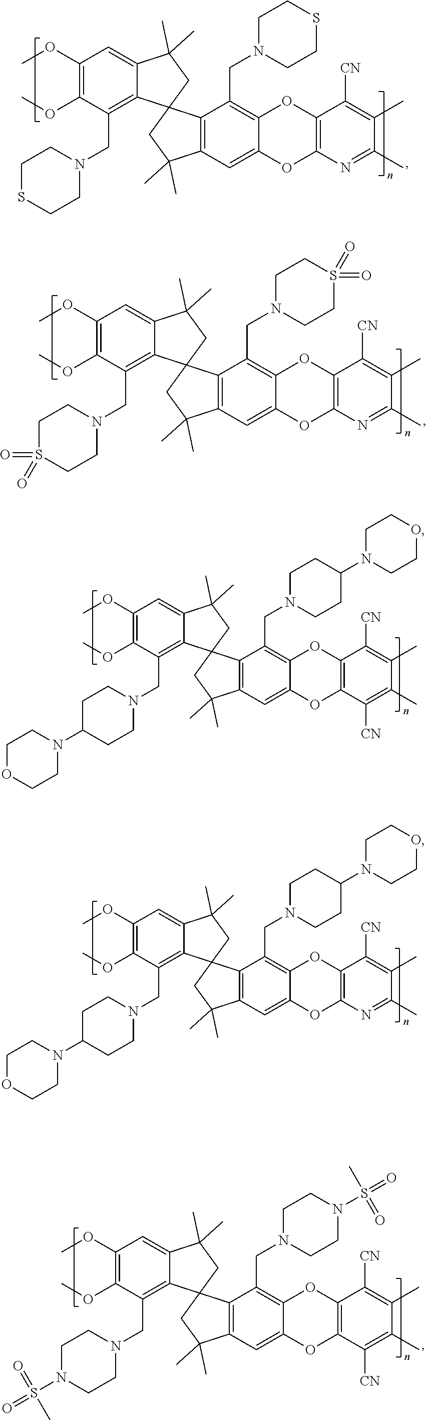

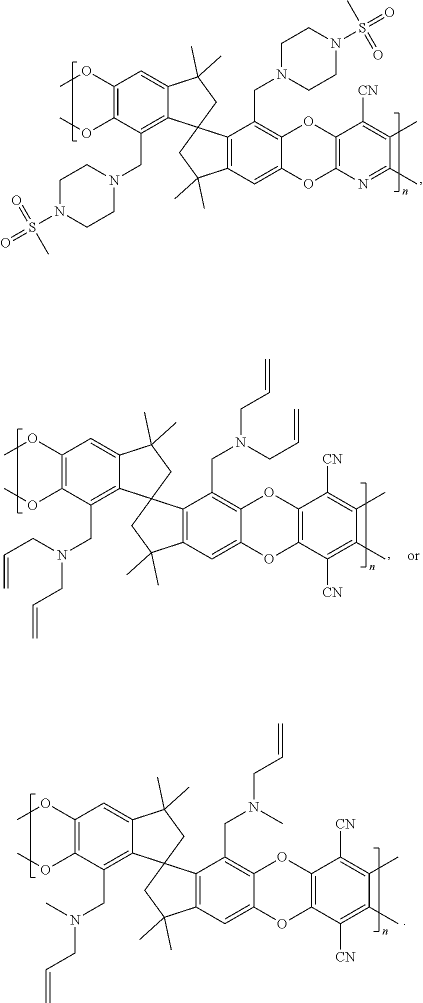

In some embodiments, the polymer of Formula I, or a salt thereof, is the polymer:

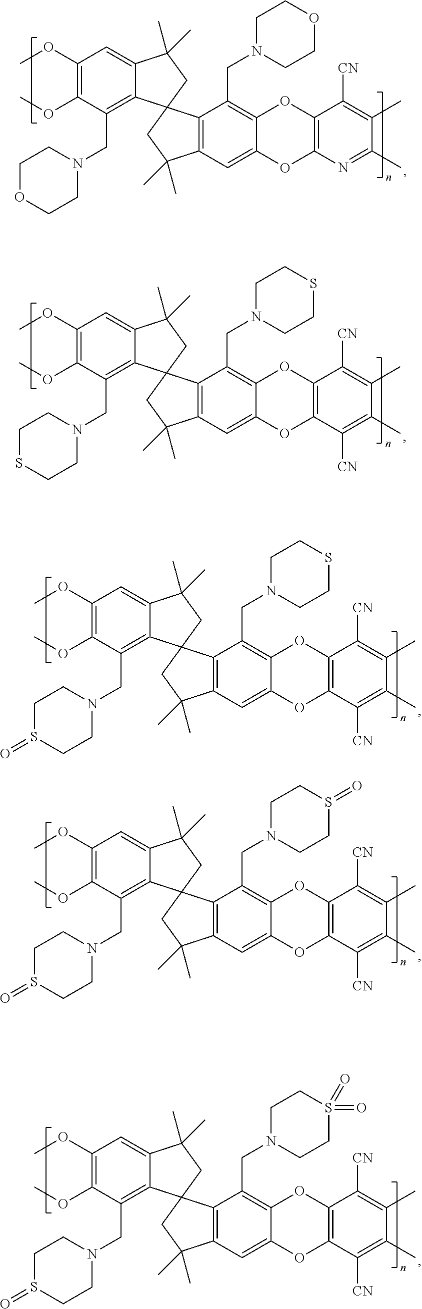

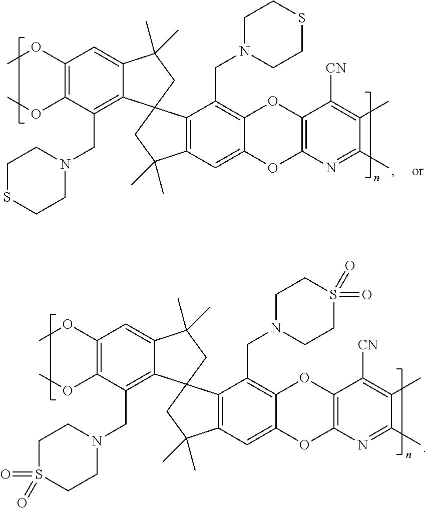

In some embodiments, the polymer of Formula I, or a salt thereof, is the polymer:

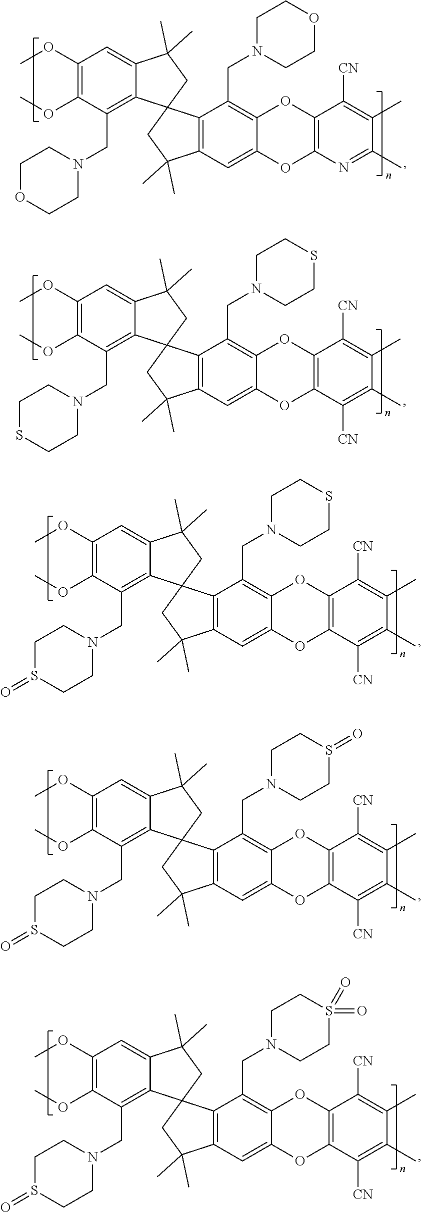

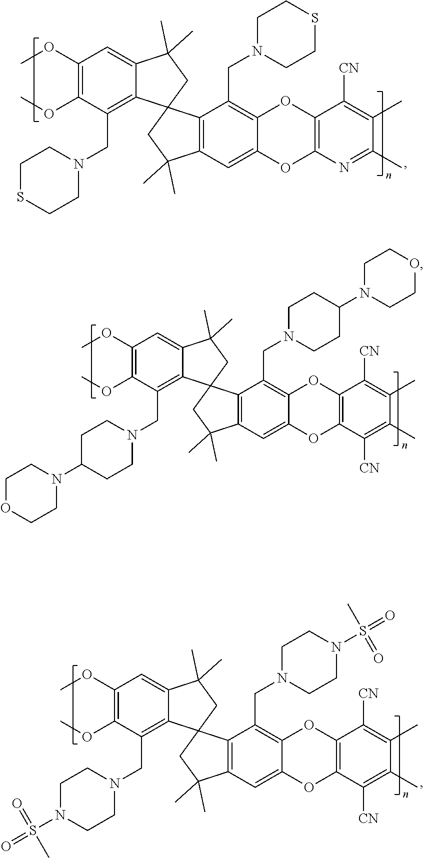

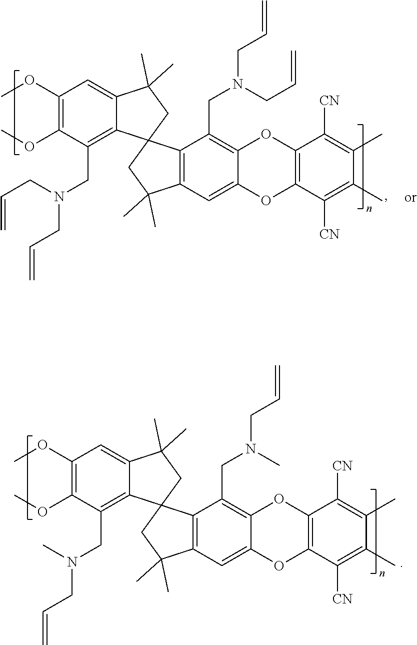

The polymers of the present invention can be prepared from a variety of monomers. In some embodiments, the present invention provides a compound of Formula II:

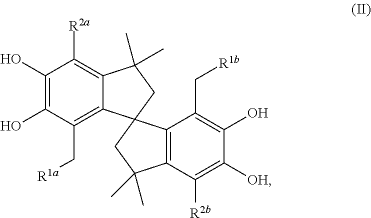

wherein:
R^{1a} and R^{1b} are each independently NR^{1a1}R^{1a2}, a 5-10 membered heterocycloalkyl having 1-4 heteroatoms each independently N, O or S, or a 5-10 membered heteroaryl having 1-4 heteroatoms each independently N, O or S, wherein the heterocycloalkyl and heteroaryl are each independently substituted with 0, 1, 2 or 3 R^{1c} groups;
each R^{1a1} and R^{1a2} is independently C₁₋₆ alkyl, C₂₋₆ alkenyl, C₂₋₆ alkynyl, or C₅₋₈ cycloalkenyl;
alternatively, R^{1a1} and R^{1a2} are combined with the atom to which they are attached to form a 5 to 8 membered heterocycloalkenyl having 0 or 1 additional heteroatoms independently N, O, or S;
each R^{1c} is independently C₁₋₆ alkyl, C₂₋₆ alkenyl, C₂₋₆ alkynyl, C₁₋₆ hydroxyalkyl, C₁₋₆ alkoxy, C₂₋₆ alkoxyalkyl, halogen, C₁₋₆ haloalkyl, C₁₋₆ haloalkoxy, ═O, ═NH, —CN, —NO₂, —C(O)H, —C(O)R^{1d}, —C(O)OR^{1d}, —S(O)₂—C₁₋₆ alkyl, —C₁₋₆ alkyl-(SO₃⁻), —O(P═O)(OR^{1d})₂, a 3-10 membered heterocycloalkyl having 1-4 heteroatoms each independently N, O or S, or a 3-10 membered heteroaryl having 1-4 heteroatoms each independently N, O or S, wherein each heterocycloalkyl and heteroaryl is independently substituted with 0, 1, 2, 3, 4, 5 or 6 R^{1e} groups;
R^{1d} is C₁₋₆ alkyl or C₁₋₆ hydroxyalkyl;
each R^{1e} is independently C₁₋₆ alkyl, C₂₋₆ alkenyl, C₂₋₆ alkynyl, C₁₋₆ hydroxyalkyl, C₁₋₆ alkoxy, C₂₋₆ alkoxyalkyl, halogen, C₁₋₆ haloalkyl, C₁₋₆ haloalkoxy, ═CH₂, ═O, ═NH, —CN, or —NO₂;
R^{2a} and R^{2b} are each independently hydrogen or C₁₋₆ alkyl,
wherein when R^{2a} and R^{2b} are each hydrogen, and R^{1c} is absent, then R^{1a} and R^{1b} are other than pyrrolidine and morpholine, and
wherein when R^{2a} and R^{2b} are each hydrogen, and R^{1a} and R^{1b} are each piperazine, then R^{1c} is other than —C(O)OR^{1d}.

In some embodiments, the present invention provides a compound of Formula II:

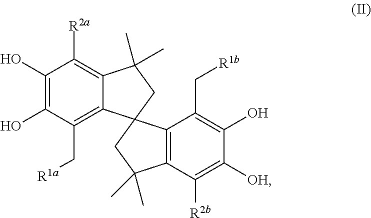

wherein:
R^{1a} and R^{1b} are each independently a 5-10 membered heterocycloalkyl having 1-4 heteroatoms each independently N, O or S, or a 5-10 membered heteroaryl having 1-4 heteroatoms each independently N, O or S, wherein the heterocycloalkyl and heteroaryl are each independently substituted with 0, 1, 2 or 3 R^{1c} groups;
each R^{1c} is independently C₁₋₆ alkyl, C₂₋₆ alkenyl, C₂₋₆ alkynyl, halogen, C₁₋₆ haloalkyl, ═O, ═NH, —CN, —NO₂, —C(O)H, —C(O)R^{1d}, —C(O)OR^{1d}, —S(O)₂—C₁₋₆ alkyl, —C₁₋₆ alkyl-(SO₃⁻), —O(P═O)(OR^{1d})₂, a 3-10 membered heterocycloalkyl having 1-4 heteroatoms each independently N, O or S, or a 3-10 membered heteroaryl having 1-4 heteroatoms each independently N, O or S;
R^{1d} is C₁₋₆ alkyl or C₁₋₆ hydroxyalkyl;
R^{2a} and R^{2b} are each independently hydrogen or C₁₋₆ alkyl,
wherein when R^{2a} and R^{2b} are each hydrogen, and R^{1c} is absent, then R^{1a} and R^{1b} are other than pyrrolidine and morpholine, and
wherein when R^{2a} and R^{2b} are each hydrogen, and R^{1a} and R^{1b} are each piperazine, then R^{1c} is other than —C(O)OR^{1d}.

Each embodiment of R^{1a}, R^{1b}, R^{1c}, R^{1d}, R^{2a} and R^{2b} of Formula II can be defined as described above for the polymer of Formula I.

In some embodiments, the compound of Formula II is:

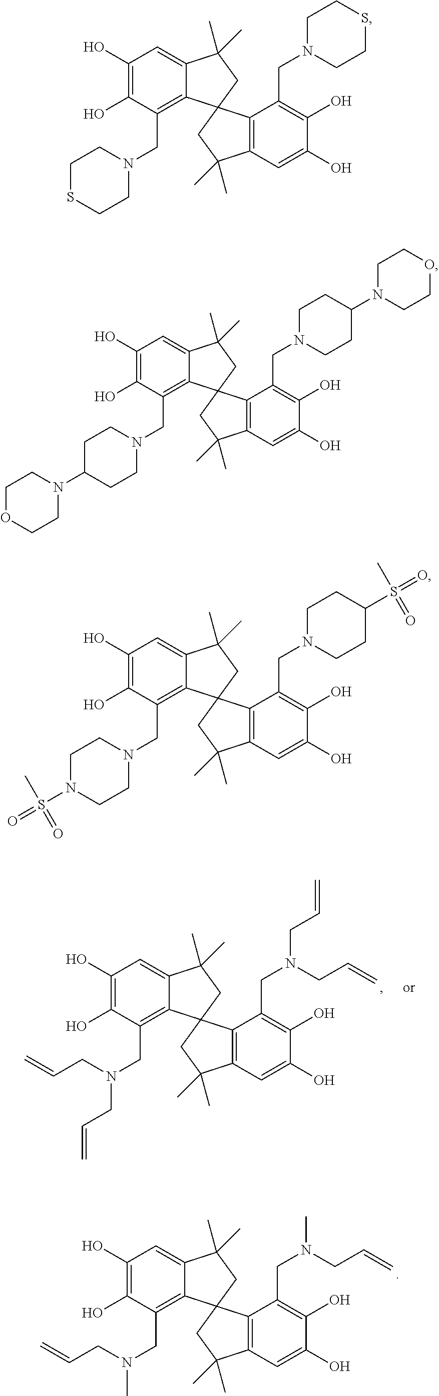

In some embodiments, the compound of Formula II is:

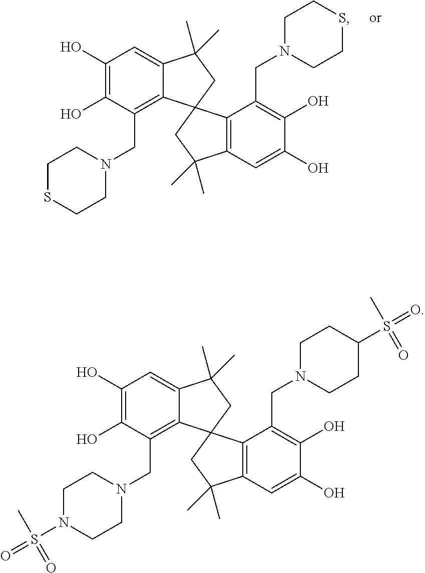 [SMILES: CC1(C)CC2(CC(C)(C)c3cc(O)c(O)c(CN4CCSCC4)c32)c2c1cc(O)c(O)c2CN1CCSCC1 ; CC1(C)CC2(CC(C)(C)c3cc(O)c(O)c(CN4CCN(S(C)(=O)=O)CC4)c32)c2c1cc(O)c(O)c2CN1CCC(S(C)(=O)=O)CC1]

### III. Preparation of Spirobisindane Polymers

The compounds of the present invention can be prepared by a variety of methods. In some embodiments, the present invention provides a method of making a polymer of Formula I:

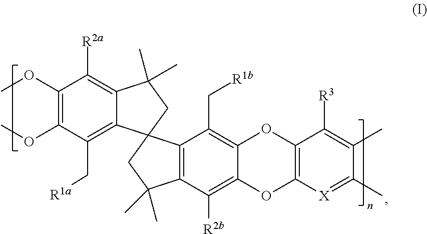

or a salt thereof, comprising:
a) forming a reaction mixture comprising a compound of Formula II:

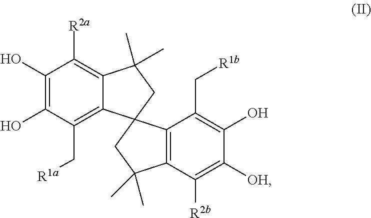

a non-nucleophilic base, a solvent, and a compound of Formula III:

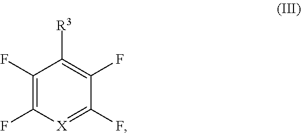

wherein the molar ratio of the compound of Formula II to the compound of Formula III is less than 1.1, under conditions suitable to form the compound of Formula I,
   wherein:
R^{1a} and R^{1b} are each independently NR^{1a1}R^{1a2}, a 5-10 membered heterocycloalkyl having 1-4 heteroatoms each independently N, O or S, or a 5-10 membered heteroaryl having 1-4 heteroatoms each independently N, O or S, wherein the heterocycloalkyl and heteroaryl are each independently substituted with 0, 1, 2 or 3 R^{1c} groups;
each R^{1a1} and R^{1a2} is independently C₁₋₆ alkyl, C₂₋₆ alkenyl, C₂₋₆ alkynyl, or C₅₋₈ cycloalkenyl;
alternatively, R^{1a1} and R^{1a2} are combined with the atom to which they are attached to form a 5 to 8 membered heterocycloalkenyl having 0 or 1 additional heteroatoms independently N, O, or S;
each R^{1c} is independently C₁₋₆ alkyl, C₂₋₆ alkenyl, C₂₋₆ alkynyl, C₁₋₆ hydroxyalkyl, C₁₋₆ alkoxy, C₂₋₆ alkoxyalkyl, halogen, C₁₋₆ haloalkyl, C₁₋₆ haloalkoxy, ═O, ═NH, —CN, —NO₂, —C(O)H, —C(O)R^{1d}, —C(O)OR^{1d}, —S(O)₂—C₁₋₆ alkyl, —C₁₋₆ alkyl-(SO₃⁻), —O(P═O)(OR^{1d})₂, a 3-10 membered heterocycloalkyl having 1-4 heteroatoms each independently N, O or S, or a 3-10 membered heteroaryl having 1-4 heteroatoms each independently N, O or S, wherein each heterocycloalkyl and heteroaryl is independently substituted with 0, 1, 2, 3, 4, 5 or 6 R^{1e} groups;
R^{1d} is C₁₋₆ alkyl or C₁₋₆ hydroxyalkyl;
each R^{1e} is independently C₁₋₆ alkyl, C₂₋₆ alkenyl, C₂₋₆ alkynyl, C₁₋₆ hydroxyalkyl, C₁₋₆ alkoxy, C₂₋₆ alkoxyalkyl, halogen, C₁₋₆ haloalkyl, C₁₋₆ haloalkoxy, ═CH₂, ═O, ═NH, —CN, or —NO₂;
R^{2a} and R^{2b} are each independently hydrogen or C₁₋₆ alkyl;
R³ is hydrogen, C₁₋₆ alkyl or —CN;
X is —N═ or —C(R⁴)═;
R⁴ is hydrogen, C₁₋₆ alkyl or —CN; and
n is an integer from 10 to 1000.

In some embodiments, the present invention provides a method of making a polymer of Formula I:

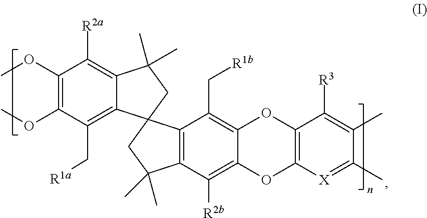

or a salt thereof, comprising:
a) forming a reaction mixture comprising a compound of Formula II:

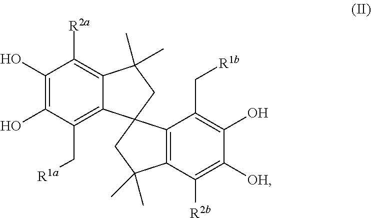

a non-nucleophilic base, a solvent, and a compound of Formula III:

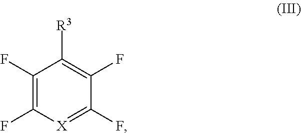

wherein the molar ratio of the compound of Formula II to the compound of Formula III is less than 1.0, under conditions suitable to form the compound of Formula I,
   wherein:
R^{1a} and R^{1b} are each independently a 5-10 membered heterocycloalkyl having 1-4 heteroatoms each independently N, O or S, or a 5-10 membered heteroaryl having 1-4 heteroatoms each independently N, O or S, wherein the heterocycloalkyl and heteroaryl are each independently substituted with 0, 1, 2 or 3 R^{1c} groups;
each R^{1c} is independently C₁₋₆ alkyl, C₂₋₆ alkenyl, C₂₋₆ alkynyl, halogen, C₁₋₆ haloalkyl, ═O, ═NH, —CN, —NO₂, —C(O)H, —C(O)R^{1d}, —C(O)OR^{1d}, —S(O)₂—C₁₋₆ alkyl, —C₁₋₆ alkyl-(SO₃⁻), —O(P═O)(OR^{1d})₂, a 3-10 membered heterocycloalkyl having 1-4 heteroatoms each independently N, O or S, or a 3-10 membered heteroaryl having 1-4 heteroatoms each independently N, O or S;
R^{1d} is C₁₋₆ alkyl or C₁₋₆ hydroxyalkyl;
R^{2a} and R^{2b} are each independently hydrogen or C₁₋₆ alkyl;
R³ is hydrogen, C₁₋₆ alkyl or —CN;
X is —N═ or —C(R⁴)═;
R⁴ is hydrogen, C₁₋₆ alkyl or —CN; and
n is an integer from 10 to 1000.

The method of the present invention can prepare the polymers of Formula I described herein.

The non-nucleophilic base can be any suitable non-nucleophilic base. In some embodiments, the method of making a polymer of Formula I, or a salt thereof, is the method wherein the non-nucleophilic base is an inorganic base. In some embodiments, the method of making a polymer of Formula I, or a salt thereof, is the method wherein the non-nucleophilic base is sodium carbonate, potassium carbonate, rubidium carbonate, or cesium carbonate.

The non-nucleophilic base can also be a non-nucleophilic amine base. Representative non-nucleophilic amine bases include, but are not limited to, trimethylamine, triethylamine, diisopropylethylamine (DIPEA or Hunig's Base), 1,8-diazabicycloundec-7-ene (DBU), 1,5-Diazabicyclo(4.3.0)non-5-ene (DBN), 2,6-di-tert-butylpyridine, quinuclidine, and lutidine.

The reaction mixture can include any suitable solvent. For example, the solvent can be a polar solvent, a non-polar solvent, a protic solvent, an aprotic solvent, or combinations thereof. In some embodiments, the method of making a polymer of Formula I, or a salt thereof, is the method wherein the solvent is a polar solvent. In some embodiments, the method of making a polymer of Formula I, or a salt thereof, is the method wherein the solvent is a polar aprotic solvent. In some embodiments, the method of making a polymer of Formula I, or a salt thereof, is the method wherein the solvent is ethyl acetate, acetonitrile, dimethylformamide, dimethylacetamide or dimethyl sulfoxide.

The molar ratio of the compound of Formula II to the compound of Formula III can be any suitable ratio. For example, the molar ratio of the compound of Formula II to the compound of Formula III can be from 0.9 to 1.1, from 0.95 to 1.05, from 0.96, to 1.04, or from 0.97 to 1.03. Other examples of the molar ratio of the compound of Formula II to the compound of Formula III can be about 1.1, 1.09, 1.08, 1.07, 1.06, 1.05, 1.04, 1.03, 1.02, 1.01, 1.0, 0.99, 0.98, 0.97, 0.96, 0.95, 0.94, 0.93, 0.92, 0.91, or about 0.90.

The molar ratio of the compound of Formula II to the compound of Formula III can be any suitable ratio less than 1.0. For example, the molar ratio of the compound of Formula II to the compound of Formula III can be less than 1.0, or from 0.9 to 0.99, from 0.95 to 0.99, from 0.96, to 0.99, from 0.97 to 0.99, or from 0.98 to 0.99. Other examples of the molar ratio of the compound of Formula II to the compound of Formula III can be about 0.99, 0.98, 0.97, 0.96, 0.95, 0.94, 0.93, 0.92, 0.91, or about 0.90. In some embodiments, the method of making a polymer of Formula I, or a salt thereof, is the method wherein the molar ratio of the compound of Formula II to the compound of Formula III is less than 1.0. In some embodiments, the method of making a polymer of Formula I, or a salt thereof, is the method wherein the molar ratio of the compound of Formula II to the compound of Formula III is from 0.95 to 0.99. In some embodiments, the method of making a polymer of Formula I, or a salt thereof, is the method wherein the molar ratio of the compound of Formula II to the compound of Formula III is from 0.98 to 0.99.

The molar ratio of the compound of Formula II to the compound of Formula III can be any suitable ratio greater than 1.0. For example, the molar ratio of the compound of Formula II to the compound of Formula III can be greater than 1.0, or from 1.01 to 1.1, from 1.01 to 1.05, from 1.01 to 1.04, from 1.01 to 1.03, or from 1.01 to 1.02. Other examples of the molar ratio of the compound of Formula II to the compound of Formula III can be about 1.01, 1.02, 1.03, 1.04, 1.05, 1.06, 1.07, 1.08, 1.09, or about 1.1. In some embodiments, the method of making a polymer of Formula I, or a salt thereof, is the method wherein the molar ratio of the compound of Formula II to the compound of Formula III is from 1.01 to 1.05. In some embodiments, the method of making a polymer of Formula I, or a salt thereof, is the method wherein the molar ratio of the compound of Formula II to the compound of Formula III is from 1.01 to 1.03. In some embodiments, the method of making a polymer of Formula I, or a salt thereof, is the method wherein the molar ratio of the compound of Formula II to the compound of Formula III is from 1.01 to 1.02.

In some embodiments, the present invention provides a method of making the polymer of Formula I, or a salt thereof, comprising:
a) forming the reaction mixture comprising a compound of Formula II:

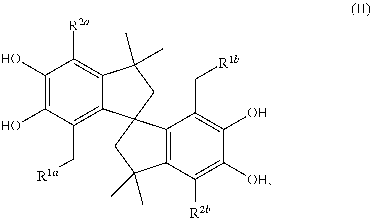

the non-nucleophilic base, the solvent, and the compound of Formula III:

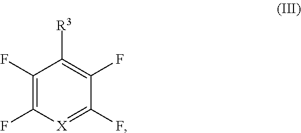

wherein the molar ratio of the compound of Formula II to the compound of Formula III is from 1.0 to 1.1, under conditions suitable to form the compound of Formula I,
   wherein:
R^{1a} and R^{1b} are each independently NR^{1a1}R^{1a2};
each R^{1a1} and R^{1a2} is independently C₁₋₆ alkyl, C₂₋₆ alkenyl, or C₅₋₈ cycloalkenyl;
R^{2a} and R^{2b} are each independently hydrogen or C₁₋₆ alkyl;
R³ is hydrogen, C₁₋₆ alkyl or —CN;
X is —C(R⁴)═;
R⁴ is hydrogen, C₁₋₆ alkyl or —CN; and
n is an integer from 10 to 1000.

In some embodiments, the present invention provides a method of making the polymer of Formula I, or a salt thereof, wherein:
R^{1a} and R^{1b} are each independently NR^{1a1}R^{1a2};
each R^{1a1} and R^{1a2} is independently C₁₋₆ alkyl, C₂₋₆ alkenyl, or C₅₋₈ cycloalkenyl;
R^{2a} and R^{2b} are each independently hydrogen or C₁₋₆ alkyl;
R³ is hydrogen, C₁₋₆ alkyl or —CN;
X is —C(R⁴)═;
R⁴ is hydrogen, C₁₋₆ alkyl or —CN; and
n is an integer from 10 to 1000.

In some embodiments, the method of making a polymer of Formula I, or a salt thereof, is the method wherein the compound of Formula II is:

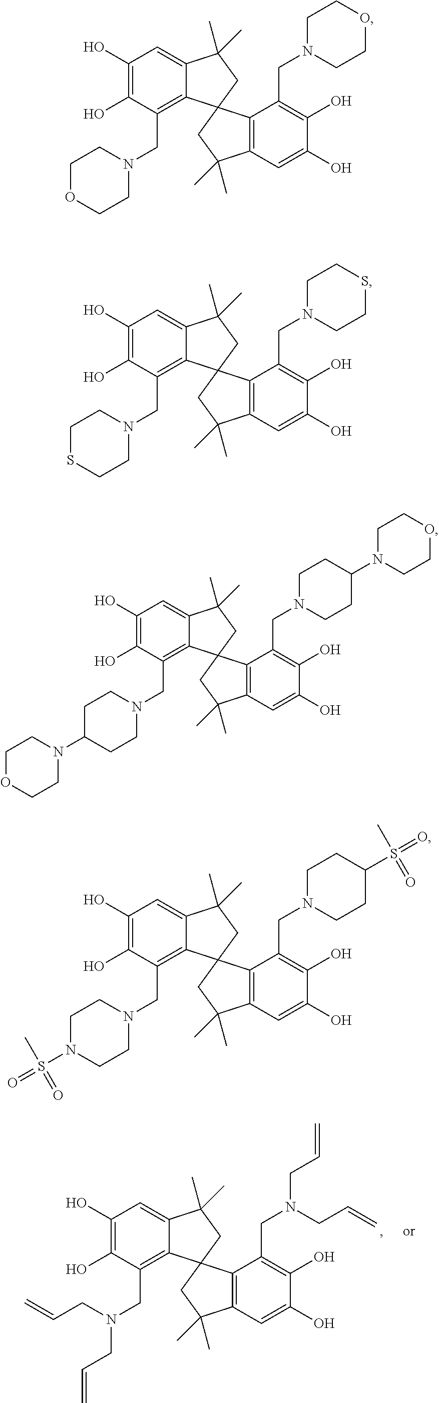 [SMILES: CC1(C)CC2(CC(C)(C)c3cc(O)c(O)c(CN4CCOCC4)c32)c2c1cc(O)c(O)c2CN1CCOCC1 ; CC1(C)CC2(CC(C)(C)c3cc(O)c(O)c(CN4CCSCC4)c32)c2c1cc(O)c(O)c2CN1CCSCC1 ; CC1(C)CC2(CC(C)(C)c3cc(O)c(O)c(CN4CCC(N5CCOCC5)CC4)c32)c2c1cc(O)c(O)c2CN1CCC(N2CCOCC2)CC1 ; CC1(C)CC2(CC(C)(C)c3cc(O)c(O)c(CN4CCN(S(C)(=O)=O)CC4)c32)c2c1cc(O)c(O)c2CN1CCC(S(C)(=O)=O)CC1 ; C=CCN(CC=C)Cc1c(O)c(O)cc2c1C1(CC2(C)C)CC(C)(C)c2cc(O)c(O)c(CN(CC=C)CC=C)c21]

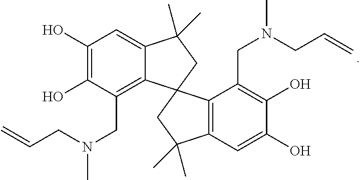 [SMILES: C=CCN(C)Cc1c(O)c(O)cc2c1C1(CC2(C)C)CC(C)(C)c2cc(O)c(O)c(CN(C)CC=C)c21]

Other embodiments of Formula II useful in the methods of preparing the polymer of Formula I are described herein.

In some embodiments, the method of making a polymer of Formula I, or a salt thereof, is the method wherein the compound of Formula III is:

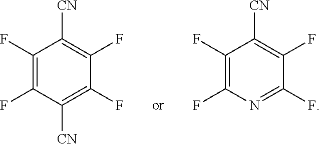 [SMILES: N#Cc1c(F)c(F)c(C#N)c(F)c1F ; N#Cc1c(F)c(F)nc(F)c1F]

In some embodiments, the method of making a polymer of Formula I, or a salt thereof, is the method wherein the compound of Formula III is:

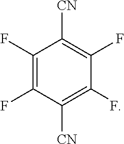 [SMILES: N#Cc1c(F)c(F)c(C#N)c(F)c1F]

In some embodiments, the method of making a polymer of Formula I, or a salt thereof, is the method wherein the compound of Formula III is:

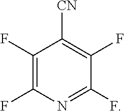 [SMILES: N#Cc1c(F)c(F)nc(F)c1F]

In some embodiments, the method of making a polymer of Formula I, or a salt thereof, is the method comprising
a) forming the reaction mixture comprising the compound of Formula II:

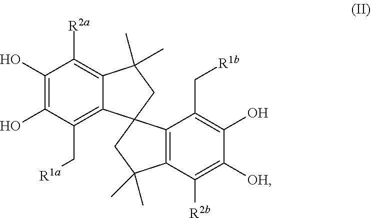

potassium carbonate, dimethylformamide, and the compound of Formula III having the structure:

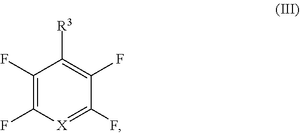

wherein the molar ratio of the compound of Formula II to the compound of Formula III is from 0.98 to 0.99, under conditions suitable to form the compound of Formula I,
   wherein:
R^{1a} and R^{1b} are each independently a 5-6 membered heterocycloalkyl having 1-3 heteroatoms each independently N, O or S, or a 5-6 membered heteroaryl having 1-3 heteroatoms each independently N, O or S;
each R^{1c} is independently C₁₋₃ alkyl, ═O, —C₁₋₃ alkyl-(SO₃⁻), —SO₂—C₁₋₃ alkyl, or a 5-6 membered heterocycloalkyl having 1-2 heteroatoms each independently N, O or S;
R^{2a} and R^{2b} are each hydrogen;
R³ is —CN;
X is —N═ or —C(R⁴)═;
R⁴ is —CN; and
subscripts n is an integer from 10 to 1000.

In some embodiments, the method of making a polymer of Formula I, or a salt thereof, is the method comprising
a) forming the reaction mixture comprising the compound of Formula II:

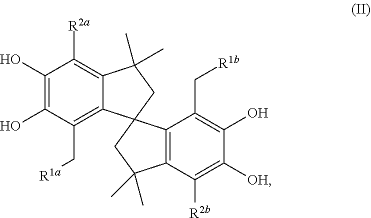

potassium carbonate, dimethylformamide, and the compound of Formula III having the structure:

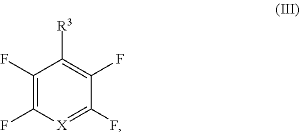

wherein the molar ratio of the compound of Formula II to the compound of Formula III is from 1.01 to 1.03, under conditions suitable to form the compound of Formula I,
   wherein:
R^{1a} and R^{1b} are each independently NR^{1a1}R^{1a2};
each R^{1a1} and R^{1a2} is independently C₁₋₃ alkyl, or C₂₋₄ alkenyl;
R^{2a} and R^{2b} are each hydrogen;
R³ is —CN;
X is —C(CN)═; and
subscripts n is an integer from 10 to 1000.

In some embodiments, the method of making a polymer of Formula I, or a salt thereof, is the method wherein:
R^{1a} and R^{1b} are each independently NR^{1a1}R^{1a2};
each R^{1a1} and R^{1a2} is independently C₁₋₃ alkyl, or C₂₋₄ alkenyl;
R^{2a} and R^{2b} are each hydrogen;
R³ is —CN;
X is —C(CN)═; and
subscripts n is an integer from 10 to 1000.

Each step of the preparation method of the present invention can be performed for any suitable reaction time. For example, the reaction time can be for minutes, hours, or days. In some embodiments, the reaction time can be for several hours, such as at least eight hours. In some embodiments, the reaction time can be for several hours, such as at least overnight. In some embodiments, the reaction time can be for several days. In some embodiments, the reaction time can be for at least two hours. In some embodiments, the reaction time can be for at least eight hours. In some embodiments, the reaction time can be for at least several days. In some embodiments, the reaction time can be for about two hours, or for about 4 hours, or for about 6 hours, or for about 8 hours, or for about 10 hours, or for about 12 hours, or for about 14 hours, or for about 16 hours, or for about 18 hours, or for about 20 hours, or for about 22 hours, or for about 24 hours. In some embodiments, the reaction time can be for about 1 day, or for about two days, or for about three days, or for about four days, or for about five days, or for about six days, or for about a week, or for about more than a week.

Each step of the preparation method of the present invention can be performed at any suitable reaction temperature. Representative temperatures include, but are not limited to, below room temperature, at room temperature, or above room temperature. Other temperatures useful in the methods of the present invention include from about −40° C. to about 65° C., or from about room temperature to about 40° C., or from about 40° C. to about 65° C., or from about 40° C. to about 60° C. In some embodiments, the reaction mixture can be at a temperature of about room temperature, or at a temperature of about 15° C., or at about 20° C., or at about 25° C. or at about 30° C., or at about 35° C., or at about 40° C., or at about 45° C., or at about 50° C., or at about 55° C., or at about 60° C., or at about 65° C.

### IV. Electrochemical Cell

In some embodiments, the present invention provides an electrochemical cell comprising an anode; a cathode; a separator comprising the polymer of Formula I; and an electrolyte.

The separator can include the polymer of the present invention alone or in combination with other components. In some embodiments, the present invention provides a coated separator, comprising:
a porous support having a first surface and a second opposing surface; and
a microporous polymer layer comprising a first polymer of intrinsic microporosity (PIM),
wherein the microporous polymer layer is coated on the first surface of the porous support.

In some embodiments, the coated separator also includes a first polymer layer between the microporous polymer layer and the first surface of the porous support. In some embodiments, the present invention provides a multi-layer coated separator, comprising:
a porous support having a first surface and a second opposing surface;
a first polymer layer; and
a microporous polymer layer comprising a first polymer of intrinsic microporosity (PIM),
wherein the first polymer layer is coated on the first surface of the porous support, and the microporous polymer layer is coated on the first polymer layer.

### Porous Support

In some embodiments, the pore size of porous support is between about 0.01 micrometers and 5 micrometers or more specifically between about 0.02 micrometers and 0.5 micrometers. The porosity of porous support may be between about 20% and 85%, or more specifically, between about 30% and 60%. One having ordinary skills in the art would understand that pore sizes may be effected by the composition of electrolyte that is provided in the pores of separator. For example, some components of separator (e.g., porous support or first polymer layer) may swell when come in contact with some materials of electrolyte causing the pore size to change. Unless specifically noted, the pore size and other like parameter refer to components of separator before they come in contact with electrolyte.

Larger pore sizes allow using porous support that is much thicker than first polymer layer without significantly undermining the overall permeability of separator to first species. In some embodiments, the thickness of porous support is between about 5 micrometers and 500 micrometers, or in specific embodiment between about 5 micrometers and 50 micrometers, or more specifically between about 10 micrometers and 30 micrometers. In the same or other embodiments, the thickness of porous support may be between about 1 to 50 times greater than the thickness of first polymer layer or, more specifically, between about 5 and 25 times greater.

Some examples of suitable materials for porous support include, but are not limited, fluoro-polymeric fibers of poly(ethylene-co-tetrafluoroethylene (PETFE) and poly(ethylenechloro-co-trifluoroethylene) (e.g., a fabric woven from these used either by itself or laminated with a fluoropolymeric microporous film), polyvinylidene difluoride, polytetrafluoroethylene (PTFE), polystyrenes, polyarylether sulfones, polyvinyl chlorides, polypropylene, polyethylene (including LDPE, LLDPE, HDPE, and ultrahigh molecular weight polyethylene), polyamides, polyimides, polyacrylics, polyacetals, polycarbonates, polyesters, polyetherimides, polyimides, polyketones, polyphenylene ethers, polyphenylene sulfides, polymethylpentene, polysulfones non-woven glass, glass fiber materials, ceramics, metal oxides, composites of organic and inorganic species, and a polypropylene membrane. Porous support may also be supplied with an additional coating of a second suitable material including, but not limited to, PTFV, PVDF, and PETFE. These examples of porous support may or may not be commercially available under the designation CELGARD from Celanese Plastic Company, Inc. in Charlotte, N.C., USA, as well as Asahi Kasei Chemical Industry Co. in Tokyo, Japan, Tonen Corporation, in Tokyo, Japan, Ube Industries in Tokyo, Japan, Nitto Denko K.K. in Osaka, Japan. Nippon Kodoshi Corporation, in Kochi, Japan, Entek in Lebanon, Oregon, USA, SK Innovation in Jongro-Gu, Korea, Sumitomo Corporation, in Tokyo, Japan, Toray Industries in Tokyo, Japan, Dupont USA, in Wilmington, DE, USA, W-Scope in Japan, and Parker Hannifin Filtration Group, in Carson, CA, USA.

In some embodiments, the coated separator is the separator wherein the porous support comprises polyethylene, polypropylene, poly(tetrafluoroethylene) (PTFE), poly(vinyl chloride) (PVC), poly(vinylidene difluoride) (PVDF), cellulose, a ceramic, or combinations thereof. In some embodiments, the coated separator is the separator wherein the porous support comprises polyethylene.

The porous support may have a thickness of between about 3 micrometers and 200 micrometers, or between about 5 micrometers and 100 micrometers, or between about 10 micrometers and 50 micrometers, or between about 9 micrometers and 25 micrometers, or between about 10 micrometers and 20 micrometers, or more specifically between about 15 micrometers and 30 micrometers. The porous support can have a thickness of about 5 micrometers, or about 6, 7, 8, 9, 10, 11, 12, 13, 14, 15, 16, 17, 18, 19, or about 20 micrometers.

### First Polymer Layer

Selective blocking characteristics of one or more polymer layers used in a separator come from the composition or specific pore architectures of these layers. For purposes of this disclosure, the term “blocking” is referred to as sieving, selecting, or excluding. In some embodiments, the pore architectures of polymer layer manifest as networks of interconnected pores with small pore sizes, narrow pore-size distribution, high surface area, and high porosity as further described below. In some embodiments, the pore architectures of polymer layer manifest as an array of channels with small pore sizes, narrow pore-size distribution, high surface area, and high porosity as further described below. In addition to these blocking properties, the first polymer layer possesses various other properties making them suitable for electrochemical cell applications, such as chemical and electrochemical stability, wettability, thickness, thermal stability, and the like.

The blocking mechanism is based on chemical exclusion (non-wettable) or a size-exclusion effect transpired at a nanometer to sub-nanometer scale where tortuous, ionically percolating, pathways are established in polymer layers. For example, a polymer layer may allow Li-ions (or other like species described below) to pass while blocking larger electrolyte solvent or the like. The membrane may be formed from a ladder polymer with angular spiro centers and absence of rotatable bonds in the polymer backbone or bonds in the backbone with restricted bond rotation. These characteristics provide inefficient solid-state packing with porosity of between about 10% and 40% or, more specifically, between about 20% and 30% of the bulk powder. The pores may then be filled with an inorganic component leaving a non-porous or partially porous polymer layer.

The first polymer layer can include any suitable polymer. In some embodiments, the multi-layer coated separator is the separator wherein the first polymer layer is substantially insoluble in carbonate electrolytes. Representative carbonate electrolytes are described within. For example, the first polymer layer can be more than 50% insoluble in the carbonate electrolyte, or more than 55, 60, 65, 70, 75, 80, 85, 90, 95, 96, 97, 98, or more than 99% insoluble in the carbonate electrolyte.

The first polymer layer can include one or more different polymer layers. For example, the first polymer layer can include a first polymer layer, a second polymer layer, or more polymer layers. In some embodiments, the multi-layer coated separator is the separator wherein the first polymer layer comprises polyacrylonitrile, poly(acrylonitrile-methyl acrylate), poly(acrylonitrile-co-methacrylic acid), poly(acrylonitrile-acrylic acid), poly(acrylonitrile-itaconic acid), poly(acrylonitrile-methyl methacrylate), poly(acrylonitrile-itaconic acid-methyl acrylate), poly(acrylonitrile-methacrylic acid-methyl acrylate), poly(acrylonitrile-vinyl pyridine), poly(acrylonitrile-vinyl chloride), poly(acrylonitrile-vinyl acetate), poly(vinylidene fluoride-co-hexafluoropropylene) (PVDF-HFP), a second polymer of intrinsic microporosity different from the first polymer of intrinsic microporosity, or combinations thereof. In some embodiments, the multi-layer coated separator is the separator wherein the first polymer layer comprises poly(acrylonitrile-co-methyl acrylate), poly(vinylidene fluoride-co-hexafluoropropylene) (PVDF-HFP), the second polymer of intrinsic microporosity different from the first polymer of intrinsic microporosity, or combinations thereof.

### PIM Polymer Layer

Polymers of intrinsic microporosity useful in the electrochemical device of the present invention include those described in U.S. Pat. Nos. 10,710,065, and 11,394,082, U.S. Publication No. 2021/0309802, and 2019/0326578, each of which is incorporated herein by reference in its entirety.

To achieve very high ion transport required to enable fast charge and high power applications, high free volume and microporosity are sought after. Polymers presenting these properties are so-called high free volume polymers. These highly permeable polymers have been applied mostly to gas separations. Some examples include certain substituted polyacetylenes (e.g. PTMSP), some perfluoropolymers (e.g. Teflon AF), certain poly(norbornene)s, polymers of intrinsic microporosity, and some polyimides. Their microporosity has been demonstrated by molecular modelling and positron lifetime spectroscopy (PALS). Highly permeable polyacetylenes have bulky side groups that inhibit conformational change and force the backbone into a twisted shape. These rigid polymer macromolecules cannot pack properly in the solid state, resulting in high free volume. The free volume distribution comprises disconnected elements as in glassy polymers and continuous microvoids. In Teflon perfluoropolymers their high free volume is due to a high barrier to rotation between neighboring dioxolane rings, coupled with weak interchain interactions, which are well known for fluoropolymers, leading to low packing density and hence high permeability. In the case of poly(norbornene)s and PTMSP, the presence of bulky trimethylsilyl groups on the ring greatly restricts the freedom of the polymer to undergo conformational change. In polymers of intrinsic microporosity (PIMs), molecular linkers containing points of contortion are held in non-coplanar orientation by rigid molecules, which do not allow the resulting polymers to pack closely and ensure high microporosity. The PIMs concept has been reported for polymides [P M Budd and N B McKewon, “Highly permeable polymers for gas separation membranes, Polymer Chemistry, 1, 63-68, 2010].

There are two different types of PIMs, i) non-network (linear) polymers which may be soluble in organic solvents, and ii) network polymers which are generally insoluble, depending on the monomer choice. PIMs possess internal molecular free volume (IMFV), which is a measure of concavity and is defined by Swager as the difference in volume of the concave unit as compared to the non-concave shape [T M Long and T M Swager, “Minimization of Free Volume: Alignment of Triptycenes in Liquid Crystals and Stretched Polymers”, Adv. Mater, 13, 8, 601-604, 2001]. While the intrinsic microporosity in linear PIMs is claimed to derive from the impenetrable concavities given by their contorted structures, in network PIMs, microporosity is also claimed to derive from the concavities associated with macrocycles. In non-network PIMs, rotation of single bonds has to be avoided, whereas the branching and crosslinking in network PIMs is thought to avoid structural rearrangement that may result in the loss of microporosity (Mckeown, 2010), so that single bonds can be present without loss of microporosity. In general, it has been observed that network PIMs possess greater microporosity than non-network PIMs due to their macrocyclization [N B McKewon, P M Budd, “Explotation of Intrinsic Microporosity in Polymer-Based materials”, Macromolecules, 43, 5163-5176, 2010]. However, since prior art network PIMs are not soluble, they can only be incorporated into a membrane if mixed as fillers with microporous soluble materials, which include soluble PIMs or other soluble polymers. There is a strict requirement in non-network PIMs that there are no single bonds in the polymer backbone, to prevent rotational freedom and so provide intrinsic microporosity. Highly rigid and contorted molecular structures are required, providing awkward macromolecular shapes that cannot pack efficiently in space. Molecules with awkward shapes are those that pose packing problems due to their concavities. However, in order to have microporosity in non-network PIMs, concave shape molecules are not sufficient as the voids must be sufficiently interconnected for transport to occur with minimal energy (i.e. intrinsic microporosity) [Macromolecules, 43, 5163-5176, 2010]. Non-network PIMs may be soluble, and so suitable for casting a membrane by phase inversion, or for use coating a support membrane to make a thin film composite. However, their solubility in a range of solvents restricts their applications in organic solvent nanofiltration [Ulbricht M, Advanced functional polymer membranes. Single Chain Polymers, 47, 2217-2262, 2006].

U.S. Pat. No. 7,690,514 B2 describes materials of intrinsic microporosity comprising organic macromolecules comprised of a first generally planar species connected by linkers having a point of contortion such that two adjacent first planar species connected by a linker are held in non-coplanar orientation. Preferred points of contortion are spiro groups, bridged ring moieties and sterically congested bonds around which there is restricted rotation. These non-network PIMs may be soluble in common organic solvents, allowing them to be cast into membranes, or coated onto other support membranes to make a thin film composite.

PIM-1 (soluble PIM) membranes exhibit gas permeabilities which are exceeded only by very high free volume polymers such as Teflon AF2400 and PTMSP, presenting selectivities above Robeson's 1991 upper bound for gas pairs such as CO₂/CH₄ and O₂/N₂. Studies have shown that permeability is enhanced by methanol treatment, helping flush out residual casting solvent and allowing relaxation of the chains [P M Budd and N B McKewon, D Fritsch, “Polymers of Intrinsic Microporosity (PIMs): High free volume polymers for membrane applications”, Macromol Symp, 245-246, 403-405, 2006].

A range of polyimides with characteristics similar to a microporous polymer (PIM) were prepared by Ghanem et al. and membrane gas permeation experiments showed these PIM-Polyimides to be among the most permeable of all polyimides and to have selectivities close to the upper bound for several important gas pairs [B G Ghanem, N B Mckeown, P M Budd, N M Al-Harbi, D Fritsch, K Heinrich, L Starannikova, A Tokarev and Y Yampolskii, “Synthesis, characterization, and gas permeation properties of a novel group of polymers with intrinsic micro porosity: PIM-polyimides”, Macromolecules, 42, 7781-7888, 2009].

U.S. Pat. No. 7,410,525 B1, describes polymer/polymer mixed matrix membranes incorporating soluble polymers of intrinsic microporosity as microporous fillers for use in gas separation applications.

International Patent Publication No. WO 2005/113121 (PCT/GB2005/002028) describes the formation of thin film composite membranes from PIMs by coating a solution of PIMs in organic solvent onto a support membrane, and then optionally crosslinking this PIM film to enhance its stability in organic solvents.

In order to improve the gas transport properties of soluble-PIMs membranes U.S. Pat. No. 7,758,751 B1, describes high performance UV-exposed membranes from polymers of intrinsic microporosity (PIMs) and their use in both gas separations, and liquid separations involving organic solvents such as olefin/paraffin, deep desulfurization of gasoline and diesel fuels, and ethanol/water separations.

In some embodiments, a microporous polymer layer comprises a polymer having a chain comprised of repeating units bonded to each other. Each unit may include a first generally planar species comprising at least one aromatic ring and also comprising a rigid linker having a site of contortion, which is a spiro group, a bridged ring moiety, or a sterically congested single covalent bond. The rigid linker restricts rotation of the first planar species in a non-coplanar orientation. In some embodiments, at least 50% by mole (or 70%, 80%, or even 90%) of the first planar species in the chain are connected by the rigid linkers to a maximum of two other planar species and being such that it does not have a cross-linked, covalently bonded 3-dimensional structure. As such, this polymer may include rigid linkers having a site of contortion. Since these polymer chains do not pack together by virtue of their rigid contorted structure, the microporous polymer layer possesses intrinsic microporosity and, in some cases, nanoporosity. As such, this combination of non-packed and non-crosslinked polymer chains extends in three dimensions. It may be also considered as a non-network polymer. Cross-linked polymers are also within the scope.

In some embodiments, the surface area of the PIM polymer layer (as measured by nitrogen adsorption or a related technique of the dry powder prior to membrane processing) prior to infilling with an inorganic component may be at least 200 m²/g or at least 500 m²/g such as between 200 m²/g and 2200 m²/g or more specifically between 600 m²/g and 900 m²/g. Representative methods for measuring surface area include nitrogen adsorption BET. The surface area is directly related to the porosity, essential for efficient transport of supporting electrolyte between electrodes and higher power cell operation. Typical porosities range from 20% to 70% or more specifically 30% to 60%. The surface area of the PIM polymer layer can be from 100 m²/g to 3000 m²/g, such as 100 m²/g, 200, 300, 400, 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, or 3000 m²/g. In some embodiments, the coated separator is the separator wherein the microporous polymer layer has a surface area of from 100 m²/g to 3000 m²/g, as measured by nitrogen adsorption BET.

In some embodiments, the coated separator is the separator wherein the average pore diameter of the microporous polymer layer prior to infilling with an inorganic component is of less than 100 nm, or from about 0.1 nm to about 20 nm, or from about 0.1 nm to about 10 nm, or from about 0.1 nm to about 5 nm, or from about 0.1 nm to about 2 nm, or from about 0.1 nm to about 1 nm. For example, the average pore diameter of the microporous polymer layer can be less than about 10 nm, or less than about 9, 8, 7, 6, 5, 4, 3, 2, or 1 nm. For example, the average pore diameter of the microporous polymer layer can be about 10 nm, or about 9, 8, 7, 6, 5, 4, 3, 2, or 1 nm. This pore diameter ensures that some materials (e.g., materials that have unit sizes greater than the pore diameter) are blocked by the microporous polymer layer, while other materials are allowed to pass (e.g., materials with smaller unit sizes). In some embodiments, the coated separator is the separator wherein the microporous polymer layer has an average pore diameter of from 0.1 nm to 10 nm. In some embodiments, the coated separator is the separator wherein the microporous polymer layer has an average pore diameter of from 0.1 nm to 2 nm. In some embodiments, the coated separator is the separator wherein the microporous polymer layer has an average pore diameter of from 0.1 nm to 1 nm.

In some embodiments, the coated separator is the separator wherein the number average molecular weight (Mₙ) of the microporous polymer layer is between 1×10³ and 2000×10³ kg/mol (kDa) or, more specifically, between 15×10³ and 500×10³ kg/mol (kDa) or between 20×10³ and 200×10³ kg/mol (kDa). Larger number average molecular weight polymers contribute to enhanced mechanical properties of the formed membrane.

In some embodiments, the coated separator is the separator wherein the weight average molecular weight (M_{w}) of the microporous polymer layer is between 1×10³ and 2000×10³ kg/mol (kDa) or, more specifically, between 15×10³ and 500×10³ kg/mol (kDa) or between 20×10³ and 200×10³ kg/mol (kDa). Larger number average molecular weight polymers contribute to enhanced mechanical properties of the formed membrane.

The microporous polymer layer can be a film cast, sprayed or coated from solution (e.g., onto the porous support), a composite comprised of a plurality of individual membrane layers, a free-standing film, or a supported film (e.g., by a porous support).

In some embodiments, the coated separator is the separator wherein the microporous polymer layer has a thickness of between about 5 nanometers and 20 micrometers, or between about 100 nanometers and 10 micrometers, or more specifically between about 500 nanometers and 5 micrometers.

The microporosity of a polymer layer is demonstrated by its high surface area (approximately 680-850 m²/g) determined using nitrogen adsorption measurements (BET calculation). The presence of the cyano and methyl groups is optional, they may be omitted or replaced with other simple substituents. Each phenyl group may contain one or more substituents. Additionally, the nature and arrangement of substituents on the spiro-indane moiety may be chosen to provide any desirable configuration around the carbon atom common to both 5-membered rings.

### Electrolyte

The electrochemical cell of the present invention also includes an electrolyte. The electrolyte can have a variety of components, such as an alkyl carbonate, a fluorinated carbonate, a diisocyanate, a lithium salt, or combinations thereof.

Representative alkyl carbonates of the electrolyte include, but are not limited to, dimethyl carbonate, ethyl methyl carbonate, diethyl carbonate, n-propyl propionate, vinylene carbonate, ethylene carbonate, fluoroethylene carbonate, or propylene carbonate. In some embodiments, the alkyl carbonate is dimethyl carbonate.

Representative fluorinated carbonates of the electrolyte include, but are not limited to, fluoroethylene carbonate, CH₃OC(O)OCH₂CF₃, CH₃OC(O)OCH₂CF₂CHF₂, CHOC(O)OCH₂CF₂CHF₂, CF₃CH₂OC(O)OCH₂CF₃, CH₃OC(O)OCH₂CF₂CF₂CF₃, CH₃CH₂OC(O)OCH₂CF₂CF₃, CH₃CH₂OC(O)OCH₂CF₂CHF₂, or CH₃OC(O)OCH₂CF₂CF₂CF₃.

Representative diisocyanates of the electrolyte include, but are not limited to, tolylene-2,4-diisocyanate, or tolylene-2,6-diisocyanate.

The lithium salt of the electrolyte compositions of the present invention can be any suitable lithium salt. For example, suitable lithium salts include, but are not limited to, lithium bis(fluorosulfonyl)imide, lithium hexafluorophosphate, lithium 4,5-dicyano-2-(trifluoromethyl)imidazolium, lithium difluoro(52xalate)borate, lithium bis(trifluoromethanesulfonyl)imide, lithium difluorophosphate, lithium nitrate, lithium perchlorate, lithium tetrafluoroborate, lithium trifluoromethanesulfonate, or combinations thereof. In some embodiments, the lithium salt can be lithium bis(fluorosulfonyl)imide, lithium hexafluorophosphate, lithium 4,5-dicyano-2-(trifluoromethyl)imidazolium, lithium difluoro(53xalate)borate, lithium bis(trifluoromethanesulfonyl)imide, lithium difluorophosphate, lithium nitrate, lithium perchlorate, lithium tetrafluoroborate, lithium trifluoromethanesulfonate, or combinations thereof.

In some embodiments, the electrolyte includes lithium bis(fluorosulfonyl)imide (LiFSi), lithium hexafluorophosphate, or combinations thereof. In some embodiments, the electrolyte includes lithium bis(fluorosulfonyl)imide (LiFSi).

The first lithium salt can be present in the electrolyte composition in any suitable amount. For example, the first lithium salt can be present in the electrolyte composition in an amount of from 0.1 to 20 mol %, from 0.1 to 20 mol %, from 1 to 20 mol %, from 5 to 20 mol %, from 5 to 15 mol %, from 8 to 12 mol %, or from 9 to 11 mol %. Representative amounts of the first lithium salt in the electrolyte compositions of the present invention include, but are not limited to, about 5 mol %, or about 6, 7, 8, 9, 10, 11, 12, 13, 14, or about 15 mol %.

The electrolyte can include one or more lithium salts. For example, the electrolyte can include 1, 2, 3, 4, or more different lithium salts as defined above. In some embodiments, the electrolyte includes a single lithium salt. In some embodiments, the electrolyte includes two different lithium salts. In some embodiments, the electrolyte includes three different lithium salts.

The electrolyte can include a second lithium salt that is different from the first lithium salt. In some embodiments, the electrolyte includes a second lithium salt that is different from the first lithium salt.

In some embodiments, the electrolyte includes a second lithium solvent that can be lithium 4,5-dicyano-2-(trifluoromethyl)imidazolium, lithium difluoro(53xalate)borate, lithium bis(trifluoromethanesulfonyl)imide, lithium difluorophosphate, lithium nitrate, lithium perchlorate, lithium tetrafluoroborate, lithium trifluoromethanesulfonate, or combinations thereof. In some embodiments, the electrolyte includes the second lithium salt that can be lithium 4,5-dicyano-2-(trifluoromethyl)imidazolium, lithium difluoro(53xalate)borate, or combinations thereof. In some embodiments, the electrolyte includes the second lithium salt that can be lithium 4,5-dicyano-2-(trifluoromethyl)imidazolium. In some embodiments, the electrolyte includes the second lithium salt that can be lithium difluoro(54xalate)borate. In some embodiments, the electrolyte includes the second lithium salt that can be lithium nitrate.

The second lithium salt can be present in the electrolyte composition in any suitable amount. For example, the second lithium salt can be present in the electrolyte composition in an amount of from 0.1 to 10 mol %, from 0.1 to 5 mol %, from 0.5 to 5 mol %, from 0.5 to 4 mol %, from 0.5 to 3.5 mol %, from 1 to 3 mol %, from 1.0 to 2.5 mol %, or from 1.5 to 2.5 mol %. Representative amounts of the second lithium salt in the electrolyte compositions of the present invention include, but are not limited to, about 1.5 mol %, or about 1.6, 1.7, 1.8, 1.9, 2.0, 2.1, 2.2, 2.3, 2.4, or about 2.5 mol %.

In some embodiments, the electrolyte includes the second lithium salt that can be present in the electrolyte in an amount of from 0.1 to 5 mol %. In some embodiments, the electrolyte includes the second lithium salt that can be present in the electrolyte in an amount of from 0.5 to 3.5 mol %. In some embodiments, the electrolyte includes the second lithium salt that can be present in the electrolyte in an amount of 1 to 3 mol %. In some embodiments, the electrolyte includes the second lithium salt that can be present in the electrolyte in an amount of from 1.5 to 2.5 mol %.

### V. Examples

Molecular weight information for PIM-13 and novel PIM examples were determined using a Waters Acquity advanced Polymer Chromatography system equipped with a refractive index detector and using chloroform as the mobile phase. Relative molecular weights were determined using a calibration curve produced from polystyrene standards ranging in molecular weight from 0.266 to 1760 kg/mol (kDa).

### Example 1: Synthesis of PIM-1-Py (a1)

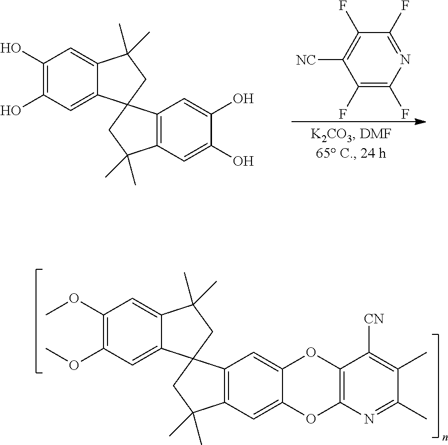

To a 500 mL two neck round bottom flask equipped with a vacuum adapter, septum, and stir bar was added 5,5′,6,6′-tetrahydroxy-3,3,3′,3′-tetramethyl-1,1′-spirobisindane (4.83 g, 14.2 mmol, 1 eq) and tetrafluorocyanopyridine (2.50 g, 14.2 mmol, 1 eq). The flask was then purged with argon through three evacuation and refill cycles before dry N,N-dimethylformamide (150 mL) was added and the reaction mixture purged with argon for 30 minutes. The reaction mixture was then heated to 65° C. and anhydrous potassium carbonate (8.00 g, 57.94 mmol, 4.08 eq) previously dried at 150° C. in vacuo and ground with a mortar and pestle was added. The reaction mixture was allowed to stir at 65° C. for 18 hours after which it was precipitated into water (500 mL), then washed with additional water (2×100 mL) and ethanol (2×100 mL). The resulting solid was dried in vacuo, then dissolved into tetrahydrofuran (THF) at 50 mg/mL. This solution was precipitated into ethanol, and the precipitated polymer isolated by vacuum filtration and dried in vacuo to yield PIM-13 (a1, 5.33 g, 86% yield, Mw=51.5 kg/mol (kDa)) as a bright yellow solid. ¹H-NMR (400 MHZ, CDCl₃, δ): δ 6.76 (1H, d), 6.39 (1H, D), 2.23 (2H, d), 1.33 (6H, d).

### Example 2: Preparation PIM-13 (b2)

### Synthesis of SBI-morpholine (b1)

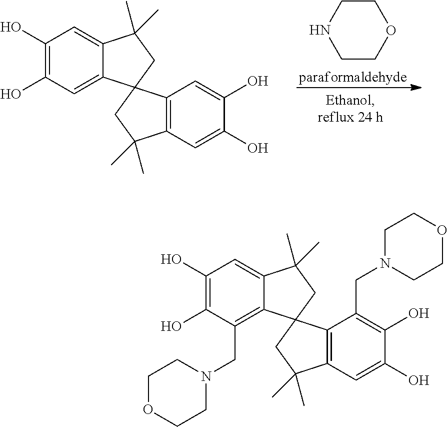 [SMILES: CC1(C)CC2(CC(C)(C)c3cc(O)c(O)cc32)c2cc(O)c(O)cc21 ; C1COCCN1 ; CC1(C)CC2(CC(C)(C)c3cc(O)c(O)c(CN4CCOCC4)c32)c2c1cc(O)c(O)c2CN1CCOCC1]

To a 1 L two-neck round bottom flask equipped with a reflux condenser was added paraformaldehyde (4.41 g, 147 mmol, 2.5 eq), morpholine (12.65 mL, 147 mmol, 2.5 eq), and ethanol (300 mL). The reaction mixture was purged with argon for 25 minutes, then heated to reflux for one hour. After heating for one hour, 5,5′,6,6′-tetrahydroxy-3,3,3′,3′-tetramethyl-1,1′-spirobisindane (20 g, 58.8 mmol, 1 eq) was added and the reaction mixture stirred at reflux under argon for 24 hours after which a white precipitate was observed. The reaction was then cooled to room temperature, poured into heptane (700 mL), and cooled to 0° C. The reaction mixture was then filtered, washed with heptane (2×50 mL), and dried in vacuo to yield SBI-morpholine (5.22 g, 16.5% yield). ¹H-NMR (400 MHZ, DMSO-d6, δ): δ 11.01 (s, 2H), 8.41 (s, 2H), 6.52 (s, 2H), 3.52 (s, 8H), 3.07 (dd, 4H), 2.25 (s, 8H), 2.17 (dd, 4H), 1.32 (s, 6H), 1.20 (s, 6H).

### Synthesis of PIM-13 (b2)

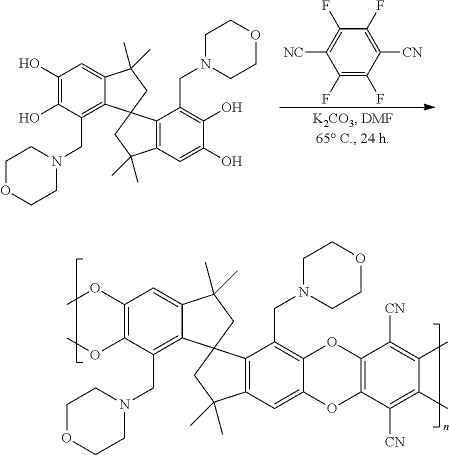

To a 500 mL two neck round bottom flask equipped with a vacuum adapter, septum, and stir bar was added SBI-morpholine (12.50 g, 23.2 mmol, 0.98 eq) and tetrafluoroterephthalonitrile (4.74 g, 23.68 mmol, 1 eq). The flask was then purged with argon through three evacuation and refill cycles before dry N,N-dimethylformamide (250 mL) was added and the reaction mixture purged with argon for 30 minutes. The reaction mixture was then heated to 65° C. and anhydrous potassium carbonate (13.35 g, 96.61 mmol, 4.08 eq) previously dried at 150° C. in vacuo and ground with a mortar and pestle was added. The reaction mixture was allowed to stir at 65 C for 18 hours after which it was precipitated into water (500 mL), then washed with additional water (2×50 mL) and ethanol (2×50 mL). The resulting solid was dried in vacuo, then dissolved into THE at 50 mg/mL. This solution was precipitated into ethanol (500 mL), and the precipitated polymer isolated by vacuum filtration and dried in vacuo to yield PIM-13 (b2, 12.2 g, 81.5% yield, Mw=80 kg/mol (kDa)) as a bright yellow solid. ¹H-NMR (400 MHZ, CDCl₃, δ): δ 6.81 (1H, s), 3.54 (4H, s, br), 3.0 (3H, m, br), 2.24 (5H, s, br), 1.36 (6H, d).

Decreasing this mol fraction from 1 to 0.98 increases the proportion of high molecular weight fragments in the polymer, as evidenced by the increases in M_{w} and M_{z} upon this change.

TABLE 1
Study of Mol Fraction of SBI-morpholine (b1)

| Mol Fraction SBI- | Mn | Mw (kg/mol | Mz (kg/mol | |
|---|---|---|---|---|
| morpholine (b1) | (kg/mol)(kDa)) | (kDa)) | (kDa)) | PDI |
| 1 | 16.6 | 32.3 | 50.5 | 1.95 |
| 0.99 | 18.0 | 39.8 | 68.1 | 2.20 |
| 0.98 | 31.5 | 80.0 | 165 | 2.54 |

TABLE 2
Comparison to prior methods

| | | Example 2, Polymer 1-6 |
|---|---|---|
| | Example 2 | of WO2020/037246 |
| Equivalents | 1 | 1 |
| tetrafluoroterephthalonitrile | | |
| Equivalents SBI | 0.98 | 1 |
| morpholine | | |
| Equivalents potassium | 4.08 | 4 |
| carbonate | | |
| Concentration of | 0.095 | 0.28 |
| tetrafluoroterephthalonitrile | | |
| (M) | | |
| Mn (kg/mol (kDa)) | 31.5 | 21.6 |
| Mw (kg/mol (kDa)) | 80.0 | 33.1 |
| PDI | 2.54 | 1.53 |
| Reaction Yield, after | 81.5% | 81% |
| purification (%) | | |

### Example 3: Synthesis of PIM-13-Py (b3)

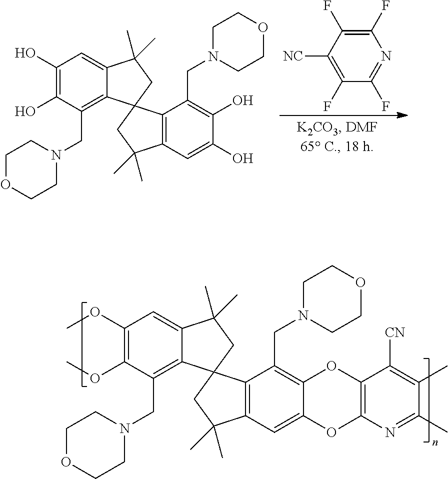

To a dry 250 mL two-neck round bottom flask was added SBI-morpholine (1, 5.81 g, 10.79 mmol, 1.0 eq.), tetrafluorocyanopyridine (1.90 g, 10.79 mmol, 1 eq), and anhydrous dimethylformamide (114 mL). The reaction mixture was purged with argon for 25 minutes, then heated to 65° C. After reaching 65° C., anhydrous potassium carbonate (6.08 g, 44.03 mmol, 4.08 eq) previously dried at 150° C. in vacuo and ground with a mortar and pestle was added. The reaction mixture was then stirred at 65° C. for 18 hours under argon, after which it was precipitated into water (500 mL), then washed with additional water (2×50 mL) and ethanol (2×50 mL). The resulting solid was dried in vacuo, then dissolved into THE at 50 mg/mL. This solution was precipitated into ethanol (500 mL), and the precipitated polymer was isolated by vacuum filtration and dried in vacuo to yield bright yellow PIM-13-Py (M_{w}=61 kDa). ¹H-NMR (400 MHZ, CDCl₃, δ): δ 6.74 (2H, m), 2.5 (24H, m), 1.65 (6H, s), 1.42 (6H, s).

### Example 4: Synthesis of PIM-13S (c2)

### Synthesis of SBI-thiomorpholine (c1)

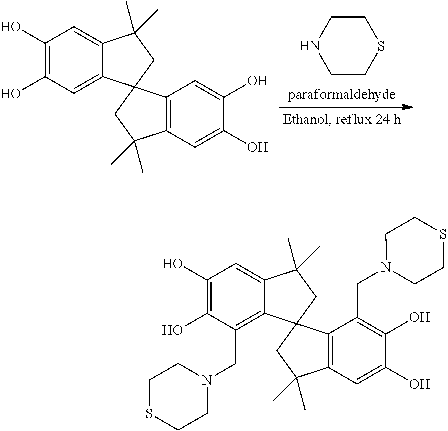 [SMILES: CC1(C)CC2(CC(C)(C)c3cc(O)c(O)cc32)c2cc(O)c(O)cc21 ; C1CSCCN1 ; CC1(C)CC2(CC(C)(C)c3cc(O)c(O)c(CN4CCSCC4)c32)c2c1cc(O)c(O)c2CN1CCSCC1]

To a 1 L two-neck round bottom flask equipped with a reflux condenser was added paraformaldehyde (4.41 g, 147 mmol, 2.5 eq), thiomorpholine (14.71 mL, 147 mmol, 2.5 eq), and ethanol (300 mL). The reaction mixture was purged with argon for 25 minutes, then heated to reflux for one hour. After heating for one hour, 5,5′,6,6′-tetrahydroxy-3,3,3′,3′-tetramethyl-1,1′-spirobisindane (20 g, 58.8 mmol, 1 eq) was added and the reaction mixture stirred at reflux under argon for 24 hours after which a white precipitate was observed. The reaction was then cooled to room temperature, poured into heptane (700 mL), and cooled to 0° C. The reaction mixture was then filtered, washed with heptane (2×50 mL), and dried in vacuo to yield SBI-thiomorpholine (5.23 g, 15.6% yield). ¹H-NMR (400 MHZ, DMSO-d6, δ): δ 10.98 (s, 2H), 8.36 (s, 2H), 6.52 (s, 2H), 3.09 (dd, 4H), 2.52 (m, 16H), 2.15 (dd, 4H), 1.30 (s, 6H), 1.20 (s, 6H).

### Synthesis of PIM-13S (c2)

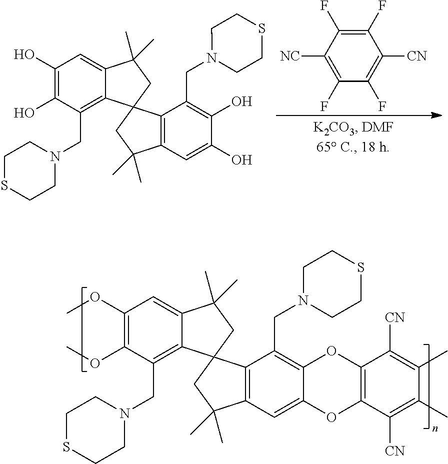

To a dry 250 mL two-neck round bottom flask was added SBI-thiomorpholine (3, 3.71 g, 6.49 mmol, 0.99 eq.), tetrafluoroterephthalonitrile (1.31 g, 6.56 mmol, 1 eq), and anhydrous dimethylformamide (65 mL). The reaction mixture was purged with argon for 25 minutes, then heated to 65° C. After reaching 65° C., anhydrous potassium carbonate (3.70 g, 26.75 mmol, 4.08 eq) previously dried at 150° C. in vacuo and ground with a mortar and pestle was added. The reaction mixture was then stirred at 65° C. for 18 hours under argon, after which it was precipitated into water (500 mL), then washed with additional water (2×50 mL) and ethanol (2×50 mL). The resulting solid was dried in vacuo, dissolved into THE at 50 mg/mL, and precipitated into ethanol (500 mL). The precipitated polymer was isolated by vacuum filtration and dried in vacuo to yield bright yellow PIM-13S (4.19 g, 94% yield, M_{w}=78 kDa). ¹H-NMR (400 MHZ, CDCl₃, δ): δ 6.82 (s, 2H), 3.07 (d, 4H), 2.48 (m, 16H), 1.41 (s, 6H), 1.32 (s, 6H).

TABLE 3
Study of Mol Fraction of SBI-thiomorpholine (c1)

| Mol Fraction SBI- | Mn (kg/mol | Mw (kg/mol | Mz (kg/mol | |
|---|---|---|---|---|
| thiomorpholine (c1) | (kDa)) | (kDa)) | (kDa)) | PDI |
| 0.995 | 13.8 | 45.5 | 82.2 | 3.29 |
| 0.990 | 14.6 | 49.6 | 91.9 | 3.38 |
| 0.985 | 14.4 | 57.7 | 117 | 4.00 |

### Example 5: Synthesis of PIM-13SO_{0.5} (c3)

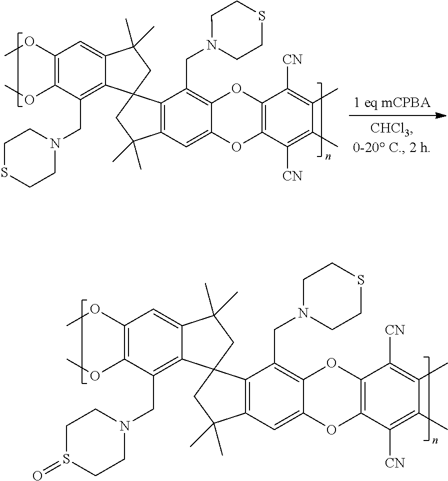

To a 100 mL round bottom flask was added PIM-13S (b2, 1000 mg, 1.45 mmol) dissolved in chloroform (20 mL). The reaction mixture was then cooled to 0° C. in an ice bath and a solution of meta-chloroperoxybenzoic acid (77%, 324 mg, 1.45 mmol, 1 eq) in chloroform (10 mL) was added dropwise. The reaction mixture was then removed from the ice bath and stirred at room temperature for 2 hours, after which it was precipitated into ethanol (300 mL). The resulting yellow solids were isolated by filtration, then stirred in concentrated ammonia solution (100 mL) for 1 hour. The solids were then filtered off and washed with water (100 mL) and ethanol (100 mL) and dried in vacuo to yield PIM-13SO_{0.5} as a bright yellow powder. ¹H-NMR (400 MHZ, CDCl₃, δ): δ 6.85 (2H, m), 2.75 (24H, m, broad), 1.41 (6H, s), 1.32 (6H, s).

### Example 6: Synthesis of PIM-13SO₁ (c4)

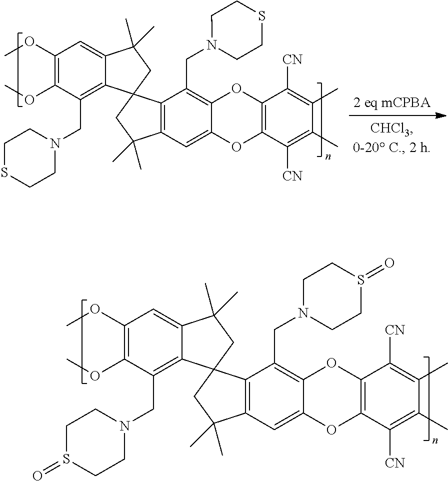

To a 100 mL round bottom flask was added PIM-13S (b2, 1000 mg, 1.45 mmol) dissolved in chloroform (20 mL). The reaction mixture was then cooled to OC in an ice bath and a solution of meta-chloroperoxybenzoic acid (77%, 649 mg, 2.89 mmol, 2 eq) in chloroform (10 mL) was added dropwise. The reaction mixture was then removed from the ice bath and stirred at room temperature for 2 hours, after which it was precipitated into ethanol (300 mL). The resulting yellow solids were isolated by filtration, then stirred in concentrated ammonia solution (100 mL) for 1 hour. The solids were then filtered off and washed with water (100 mL) and ethanol (100 mL) and dried in vacuo to yield PIM-13SO_{0.5} as a bright yellow powder. ¹H-NMR (400 MHZ, CDCl₃, δ): δ 6.85 (2H, m), 2.75 (24H, m, broad), 1.41 (6H, s), 1.32 (6H, s).

### Example 7: Synthesis of PIM-13SO_{1.5} (c5)

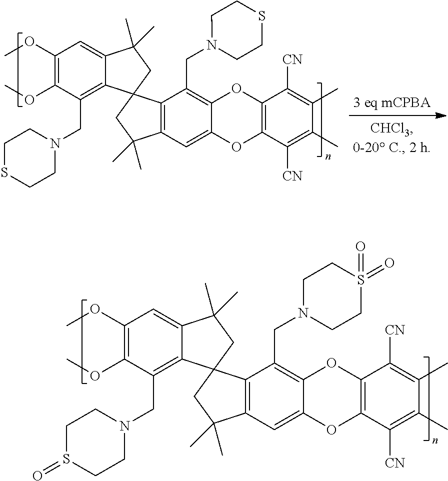

To a 100 mL round bottom flask was added PIM-13S (b2, 1000 mg, 1.45 mmol) dissolved in chloroform (20 mL). The reaction mixture was then cooled to OC in an ice bath and a solution of meta-chloroperoxybenzoic acid (77% purity, 973 mg, 4.34 mmol, 3 eq) in chloroform (10 mL) was added dropwise. The reaction mixture was then removed from the ice bath and stirred at room temperature for 2 hours, after which it was precipitated into ethanol (300 mL). The resulting yellow solids were isolated by filtration, then stirred in concentrated ammonia solution (100 mL) for 1 hour. The solids were then filtered off and washed with water (100 mL) and ethanol (100 mL) and dried in vacuo to yield PIM-13SO_{1.5} as a bright yellow powder. ¹H-NMR (400 MHZ, CDCl₃, δ): δ 6.85 (2H, broad), 2.75 (24H, m, broad), 1.41 (6H, broad), 1.32 (6H, broad).

### Example 8: Synthesis of PIM-13S-Py (c6)

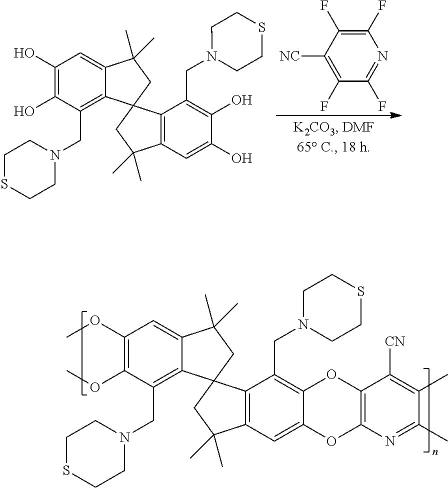

To a dry 250 mL two-neck round bottom flask was added SBI-thiomorpholine (3, 6.35 g, 11.13 mmol, 0.98 eq.), tetrafluorocyanopyridine (2.00 g, 11.36 mmol, 1 eq), and anhydrous dimethylformamide (120 mL). The reaction mixture was purged with argon for 25 minutes, then heated to 65° C. After reaching 65° C., anhydrous potassium carbonate (6.40 g, 46.34 mmol, 4.08 eq) previously dried at 150° C. in vacuo and ground with a mortar and pestle was added. The reaction mixture was then stirred at 65° C. for 18 hours under argon, after which it was precipitated into water (500 mL), then washed with additional water (2×50 mL) and ethanol (2×50 mL). The resulting solid was dried in vacuo, then dissolved into THF at 50 mg/mL. This solution was precipitated into ethanol (500 mL), and the precipitated polymer was isolated by vacuum filtration and dried in vacuo to yield bright yellow PIM-13S-Py (7.09 g, 94% yield, M_{w}=53 kDa). ¹H-NMR (400 MHZ, CDCl₃, δ): δ 6.74 (m, 2H), 3.07 (d, 4H), 2.47 (m, 16H), 1.39 (s, 6H), 1.31 (s, 6H).

### Example 9: Synthesis of PIM-4-morpholinopiperidine (e2)

### Synthesis of SRI-4-morpholinopiperidine (e1)

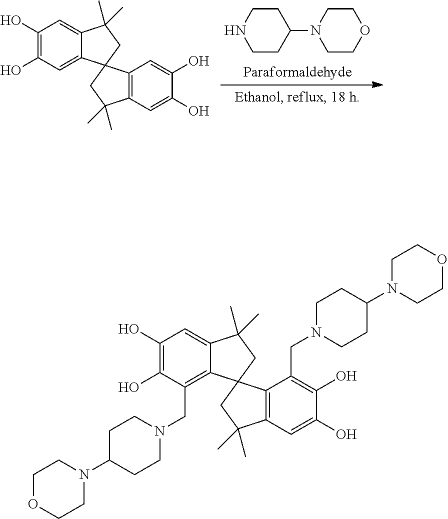 [SMILES: CC1(C)CC2(CC(C)(C)c3cc(O)c(O)cc32)c2cc(O)c(O)cc21 ; C1CC(N2CCOCC2)CCN1 ; CC1(C)CC2(CC(C)(C)c3cc(O)c(O)c(CN4CCC(N5CCOCC5)CC4)c32)c2c1cc(O)c(O)c2CN1CCC(N2CCOCC2)CC1]

The compound can be prepared by methods known in the art.

### Synthesis of PIM-4-morpholinopiperidine (e2)

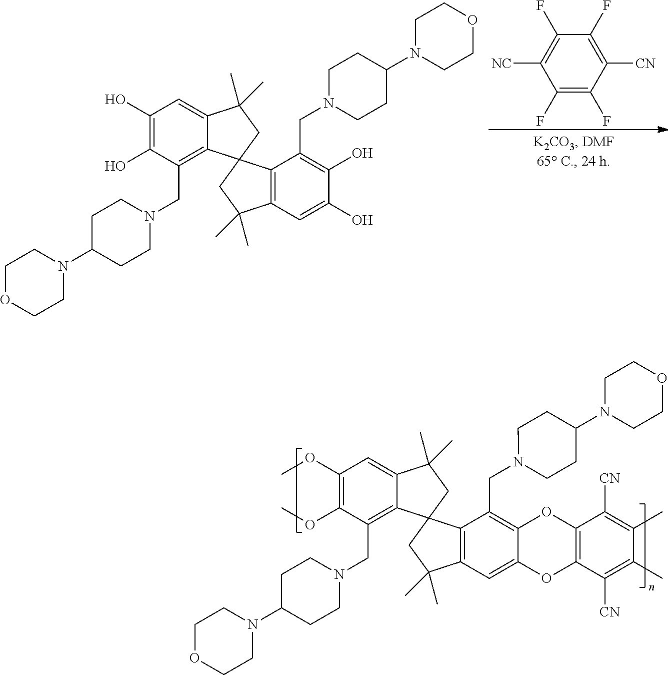

The polymer PIM-4-morpholinopiperidine can be prepared by the methods described herein.

### Example 10: Synthesis of PIM-piperizine-MeSO₂ (f2)

### Synthesis of SBI-piperizine-MeSO₂ (f1)

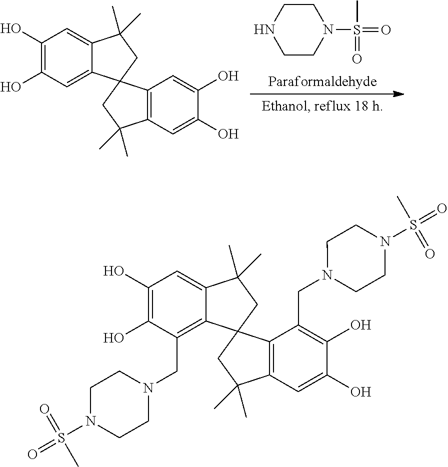

To a 250 L two-neck round bottom flask equipped with a reflux condenser was added paraformaldehyde (1.10 g, 36.7 mmol, 2.5 eq), piperazine methylsulfate (6.03 g, 36.7 mmol, 2.5 eq), and ethanol (75 mL). The reaction mixture was purged with argon for 25 minutes, then heated to reflux for one hour. After heating for one hour, 5,5′,6,6′-tetrahydroxy-3,3,3′,3′-tetramethyl-1,1′-spirobisindane (5 g, 14.7 mmol, 1 eq) was added and the reaction mixture stirred at reflux under argon for 24 hours after which a white precipitate was observed. The reaction was then cooled to room temperature, solvent removed by rotary evaporation, and the resulting solids purified using column chromatography on a silica column with an ethyl acetate and hexane mixture mobile phase and dried in vacuo to yield SBI-piperizine-MeSO₂ (1.29 g, 12.6% yield). ¹H-NMR (400 MHZ, DMSO-d6, δ): δ 10.52 (2H, s), 8.31 (2H, s), 6.53 (2H, s), 3.12 (12H, m), 2.25 (12H, m), 1.32 (6H, s), 1.18 (6H, s).

### Synthesis of PIM-piperizine-MeSO₂ (f2)

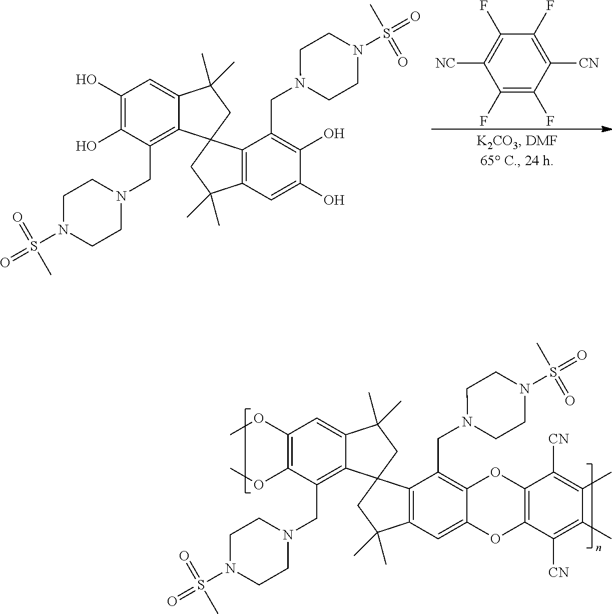

The polymer PIM-piperazine-MeSO₂ can be prepared by methods described herein.

### Example 11: Additional Polymers

The following polymers can be prepared using the methods described herein.

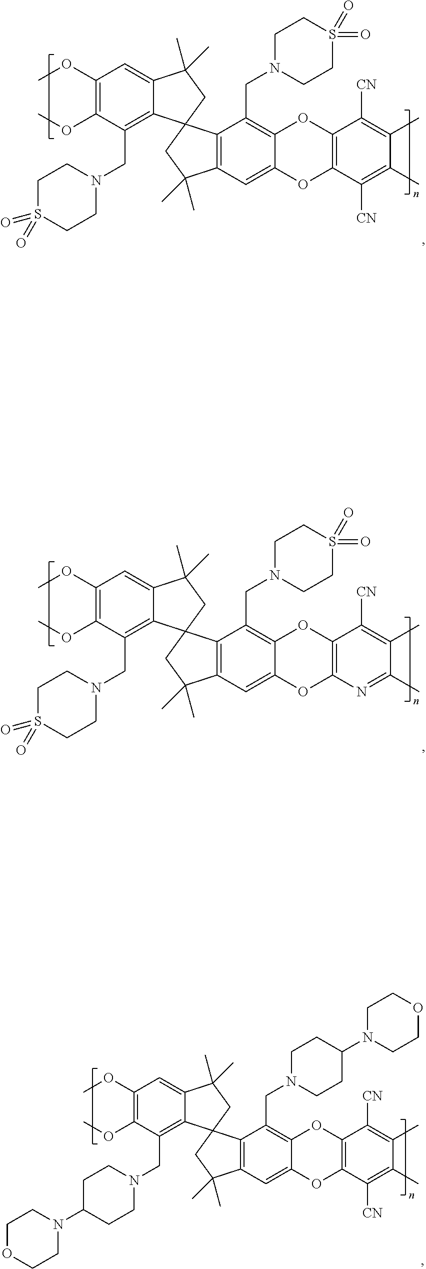

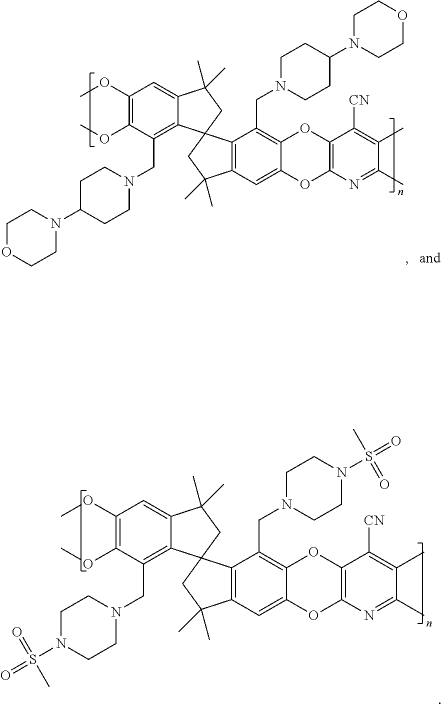

### Example 12: Synthesis of PIM-diallylamine

### Synthesis of SBI-diallylamine (g1)

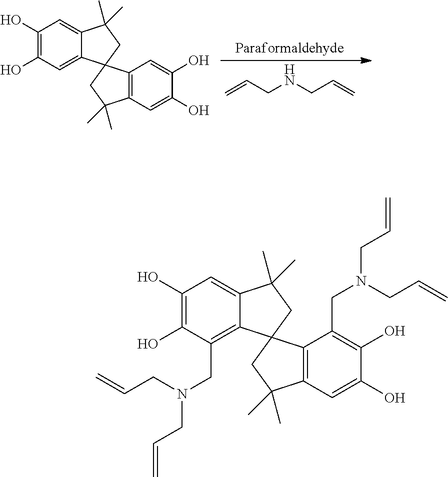

To a 2-neck 2 L round bottom flask equipped with a reflux condenser and septum was added paraformaldehyde (14.7 g, 490 mmol, 2.5 eq), toluene (1000 mL), and diallylamine (47.6 g, 490 mmol, 2.5 eq). The mixture was then heated to reflux under nitrogen until homogeneous (˜30 minutes). Then, 5,5′,6,6′-tetrahydroxy-3,3,3′,3′-tetramethyl-1,1′-spirobisindane (66.7 g, 196 mmol, 1 eq) was added and the reaction mixture stirred at reflux for 4 hours. The reaction mixture was then cooled to room temperature, solvent removed by rotary evaporation, and the resulting solids recrystallized in isopropanol to yield SBI-diallylamine (59.8 g, 54.6%) as a white crystalline solid. ¹H-NMR (400 MHZ, DMSO-d6, δ): δ 11.51 (1H, s), 8.31 (1H, s), 6.50 (1H, s), 5.64 (2H, m), 5.10 (4H, dd), 3.19 (1H, d), 3.09 (1H, d), 2.93 (2H, dd), 2.82 (2H, dd), 2.17 (1H, d), 2.08 (1H, d), 1.30 (3H, s), 1.19 (3H, s).

### Synthesis of PIM-diallylamine (g2)

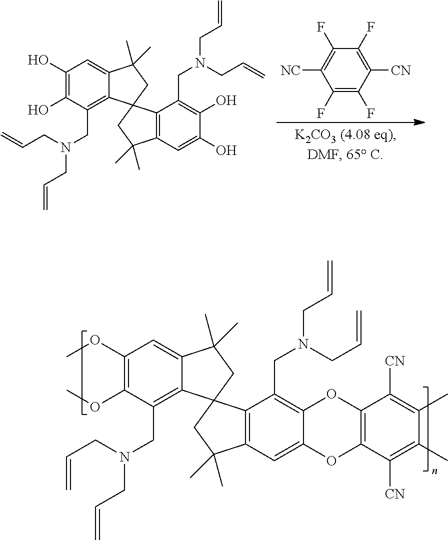

To a 500 mL round bottom flask was added tetrafluoroterephthalonitrile (3.00 g, 15 mmol, 1 eq), SBI-diallylamine (8.55 g, 15.3 mmol, 1.02 eq) and anhydrous N,N-dimethylformamide (160 mL). The reaction mixture was then heated to 65° C. under nitrogen and potassium carbonate (8.46 g, 61.2 mmol, 4.08 eq) added. The reaction mixture was further stirred at 65° C. for 16 hours, after which it was cooled to room temperature, precipitated into deionized water (700 mL), and the resulting solids filtered. These solids were further washed with additional water (200 mL) and ethanol (200 mL), then dried in vacuo. This crude solid was then stirred for 16 hours as a 25 mg/mL mixture in 1:1 methyl-ethyl-ketone/Ethanol (vol/vol) and filtered to yield PIM-diallylamine (8.31 g, 81.6%) as a bright yellow solid. ¹H-NMR (400 MHZ, CDCl₃, δ): δ 6.83 (1H, s), 5.51 (2H, s), 4.98 (4H, s), 3.24 (2H, d), 2.76 (5H, m), 2.19 (1H, s), 1.38 (3H, s), 1.34 (3H, s).

### Example 13: Synthesis of PIM-allylmethylamine

### Synthesis of SBI-allylmethylamine (h1)

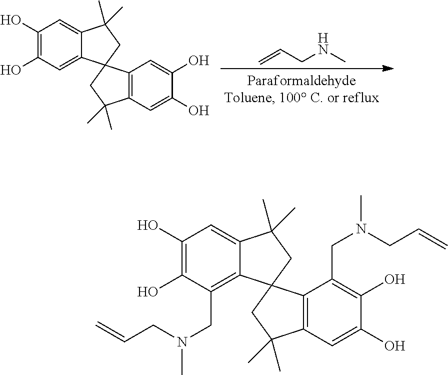

To a 2-neck 500 mL round bottom flask equipped with a reflux condenser and septum was added paraformaldehyde (2.20 g, 73.4 mmol, 2.5 eq), toluene (150 mL), and allylmethylamine (5.22 g, 73.4 mmol, 2.5 eq). The mixture was then heated to reflux under nitrogen until homogeneous (˜30 minutes). Then, 5,5′,6,6′-tetrahydroxy-3,3,3′,3′-tetramethyl-1,1′-spirobisindane (10.0 g, 29.4 mmol, 1 eq) was added and the reaction mixture stirred at reflux for 4 hours. The reaction mixture was then cooled to room temperature, solvent removed by rotary evaporation, and the resulting solids recrystallized in isopropanol to yield SBI-methylallylamine (14.9 g, 46.5%) as a white crystalline solid. ¹H-NMR (400 MHz, DMSO-d6, δ): δ 11.51 (1H, s), 8.26 (1H, s), 6.50 (1H, s), 5.66 (1H, m), 5.11 (1H, dd), 5.12 (1H, d), 3.13 (1H, d), 3.04 (1H, d), 2.88 (1H, dd), 2.82 (1H, dd), 2.18 (1H, d), 2.11 (1H, d), 1.99 (3H, s), 1.30 (3H, s), 1.20 (3H, s).

### Synthesis of PIM-allylmethylamine (h2)

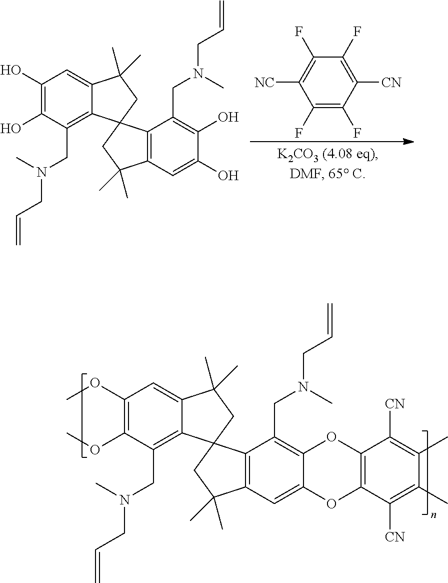

To a 20 mL scintillation vial was added tetrafluoroterephthalonitrile (300 mg, 1.5 mmol, 1 eq), SBI-allylmethylamine (745 mg, 1.47 mmol, 0.98 eq), and anhydrous N,N-dimethylformamide (16 mL). The vial was then capped, heated to 65° C., and anhydrous potassium carbonate (846 mg, 6.12 mmol, 4.08 eq) added. After stirring at 65° C. for 16 hours, the reaction mixture was precipitated into deionized water (125 mL) and the resulting solids filtered and washed with water (100 mL) and ethanol (100 mL). This crude product was then stirred for 16 hours as a 25 mg/mL suspension in 1:1 methyl-ethyl-ketone/ethanol (vol/vol), filtered, and dried in vacuo to yield PIM-allylmethylamine (784 mg, 85%) as a bright yellow solid. ¹H-NMR (400 MHZ, CDCl₃, δ): δ 6.81 (1H, s), 5.61 (1H, s), 5.06 (1H, s), 4.98 (1H, s), 3.09 (2H, d), 2.77 (2H, d), 2.00 (2H, d) 1.87 (3H, s), 1.07 (3H, s), 1.06 (3H, s).

Although the foregoing invention has been described in some detail by way of illustration and example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference. Where a conflict exists between the instant application and a reference provided herein, the instant application shall dominate.

1. A polymer of Formula I: 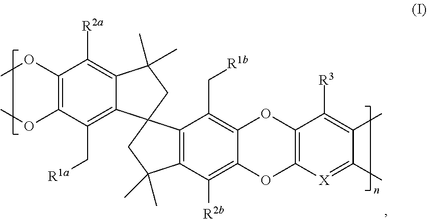
or a salt thereof, wherein:
R^{1a} and R^{1b} are each independently NR^{1a1}R^{1a2}, a 5-10 membered heterocycloalkyl having 1-4 heteroatoms each independently N, O or S, or a 5-10 membered heteroaryl having 1-4 heteroatoms each independently N, O or S, wherein the heterocycloalkyl and heteroaryl are each independently substituted with 0, 1, 2 or 3 R^{1c} groups;
each R^{1a1} and R^{1a2} is independently C₁₋₆ alkyl, C₂₋₆ alkenyl, C₂₋₆ alkynyl, or C₅₋₈ cycloalkenyl;
alternatively, R^{1a1} and R^{1a2} are combined with the atom to which they are attached to form a 5 to 8 membered heterocycloalkenyl having 0 or 1 additional heteroatoms independently N, O, or S;
each R^{1c} is independently C₁₋₆ alkyl, C₂₋₆ alkenyl, C₂₋₆ alkynyl, C₁₋₆ hydroxyalkyl, C₁₋₆ alkoxy, C₂₋₆ alkoxyalkyl, halogen, C₁₋₆ haloalkyl, C₁₋₆ haloalkoxy, ═O, ═NH, —CN, —NO₂, —C(O)H, —C(O)R^{1d}, —C(O)OR^{1d}, —S(O)₂—C₁₋₆ alkyl, —C₁₋₆ alkyl-(SO₃⁻), —O(P═O)(OR^{1d})₂, a 3-10 membered heterocycloalkyl having 1-4 heteroatoms each independently N, O or S, or a 3-10 membered heteroaryl having 1-4 heteroatoms each independently N, O or S, wherein each heterocycloalkyl and heteroaryl is independently substituted with 0, 1, 2, 3, 4, 5 or 6 R^{1e} groups;
R^{1d} is C₁₋₆ alkyl or C₁₋₆ hydroxyalkyl;
each R^{1e} is independently C₁₋₆ alkyl, C₂₋₆ alkenyl, C₂₋₆ alkynyl, C₁₋₆ hydroxyalkyl, C₁₋₆ alkoxy, C₂₋₆ alkoxyalkyl, halogen, C₁₋₆ haloalkyl, C₁₋₆ haloalkoxy, ═CH₂, ═O, —NH, —CN, or —NO₂;
R^{2a} and R^{2b} are each independently hydrogen or C₁₋₆ alkyl;
R³ is hydrogen, C₁₋₆ alkyl or —CN;
X is —N═ or —C(R⁴)═;
R⁴ is hydrogen, C₁₋₆ alkyl or —CN; and
subscript n is an integer from 10 to 1000,
wherein when R^{2a} and R^{2b} are each hydrogen, R³ is —CN, X is —C(CN)═, and R^{1c} is absent, then R^{1a} and R^{1b} are other than pyrrolidine and morpholine, and
wherein when R^{2a} and R^{2b} are each hydrogen, R³ is —CN, X is —C(CN)—, and R^{1a} and R^{1b} are each piperazine, then R^{1c} is other than —C(O)OR^{1d}.

2. The polymer of claim 1, or a salt thereof, wherein:
R^{1a} and R^{1b} are each independently a 5-10 membered heterocycloalkyl having 1-4 heteroatoms each independently N, O or S, or a 5-10 membered heteroaryl having 1-4 heteroatoms each independently N, O or S, wherein the heterocycloalkyl and heteroaryl are each independently substituted with 0, 1, 2 or 3 R^{1c} groups;
each R^{1c} is independently C₁₋₆ alkyl, C₂₋₆ alkenyl, C₂₋₆ alkynyl, halogen, C₁₋₆ haloalkyl, ═O, ═NH, —CN, —NO₂, —C(O)H, —C(O)R^{1d}, —C(O)OR^{1d}, —S(O)₂—C₁₋₆ alkyl, —C₁₋₆ alkyl-(SO₃⁻), —O(P═O)(OR^{1d})₂, a 3-10 membered heterocycloalkyl having 1-4 heteroatoms each independently N, O or S, or a 3-10 membered heteroaryl having 1-4 heteroatoms each independently N, O or S;
R^{1d} is C₁₋₆ alkyl or C₁₋₆ hydroxyalkyl;
R^{2a} and R^{2b} are each independently hydrogen or C₁₋₆ alkyl;
R³ is hydrogen, C₁₋₆ alkyl or —CN;
X is —N═ or —C(R⁴)═;
R⁴ is hydrogen, C₁₋₆ alkyl or —CN; and
subscript n is an integer from 10 to 1000,
wherein when R^{2a} and R^{2b} are each hydrogen, R³ is —CN, X is —C(CN)═, and R^{1c} is absent, then R^{1a} and R^{1b} are other than pyrrolidine and morpholine, and
wherein when R^{2a} and R^{2b} are each hydrogen, R³ is —CN, X is —C(CN)—, and R^{1a} and R^{1b} are each piperazine, then R^{1c} is other than —C(O)OR^{1d}.

3. The polymer of claim 1, or a salt thereof, wherein:
R^{1a} and R^{1b} are each independently a 5-10 membered heterocycloalkyl having 1-4 heteroatoms each independently N, O or S, wherein each heterocycloalkyl is independently substituted with 0, 1, 2 or 3 R^{1c} groups; and
each R^{1c} is independently C₁₋₆ alkyl, ═O, —S(O)₂—C₁₋₆ alkyl, or a 3-6 membered heterocycloalkyl having 1-2 heteroatoms each independently N, O or S.

4. The polymer of claim 1, or a salt thereof, wherein:
R^{1a} and R^{1b} are each independently a 5-6 membered heterocycloalkyl having 1-3 heteroatoms each independently N, O or S, wherein each heterocycloalkyl is independently substituted with 0, 1, 2 or 3 R^{1c} groups; and
each R^{1c} is independently C₁₋₃ alkyl, ═O, —S(O)₂—C₁₋₃ alkyl, or a 5-6 membered heterocycloalkyl having 1-2 heteroatoms each independently N, O or S.

5. The polymer of claim 1, or a salt thereof, wherein:
R^{1a} and R^{1b} are each independently pyrrolidine, piperidine, diazinane, triazinane, morpholine, or thiomorpholine, wherein each is independently substituted with 0, 1, 2 or 3 R^{1c} groups; and
each R^{1c} is independently methyl, ═O, —S(O)₂—C₁₋₃ alkyl, tetrahydropyran, pyrrolidine, piperidine, diazinane, thiolane, thiane, or morpholine.

6. The polymer of claim 1, or a salt thereof, wherein R^{1a} and R^{1b} are each independently:

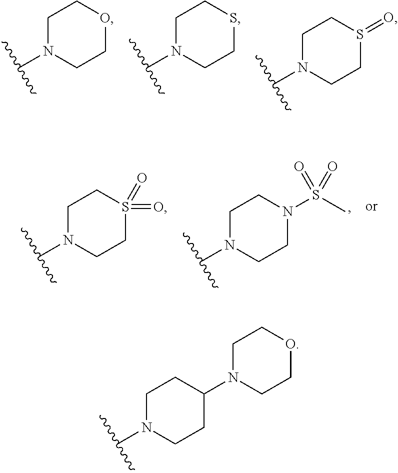

7. The polymer of claim 1, or a salt thereof, wherein:
R^{1a} and R^{1b} are each independently NR^{1a1}R^{1a2}, and
each R^{1a1} and R^{1a2} is independently C₁₋₃ alkyl, or C₂₋₄ alkenyl.

8. The polymer of claim 7, or a salt thereof, wherein:
R^{1a} and R^{1b} are each independently NR^{1a1}R^{1b1}, and
each R^{1a1} and R^{1a2} is independently methyl, ethyl, propyl, isopropyl, ethenyl, 1-propenyl, 2-propenyl, isopropenyl, 1-butenyl, 2-butenyl, 3-butenyl, or isobutenyl.

9. The polymer of claim 7, or a salt thereof, wherein R^{1a} and R^{1b} are each independently

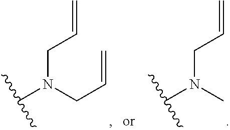

10. The polymer of claim 1, or a salt thereof, wherein R^{2a} and R^{2b} are each hydrogen.

11. The polymer of claim 1, or a salt thereof, wherein R³ is hydrogen, C₁₋₃ alkyl or —CN.

12. The polymer of claim 1, or a salt thereof, wherein R³ is —CN.

13. The polymer of claim 1, or a salt thereof, wherein X is —N═.

14. The polymer of claim 1, or a salt thereof, wherein:
X is —C(R⁴); and
R⁴ is hydrogen, C₁₋₆ alkyl or —CN.

15. The polymer of claim 1, or a salt thereof, wherein R⁴ is —CN.

16. The polymer of claim 1, wherein the salt comprises an anion that is a tetrafluoroborate, bis(70xalate)borate, difluoro(70xalate)borate, trifluorocyanoborate, cyano tris(2,2,2-trifluoroethyl) borate, carbonate, bicarbonate, carboxylate, acetate, trifluoroacetate, dicarboxylate, bis(fluorosulfonyl)imide, bis(trifluoromethanesulfonyl)imide, thiocyanate, nitrite, nitrate, hexafluorosilicate, phosphite, phosphate, difluorophosphate, hexafluorophosphate, hydrogen phosphate, dihydrogen phosphate, tetrafluoro 70xalate phosphate, difluoro(bisoxalato) phosphate, phosphonate, sulfite, bisulfite, sulfate, bisulfate, thiosulfate, sulfonate, trifluoromethanesulfonate, p-toluenesulfonate, halide, hypochlorite, chlorite, chlorate, perchlorate, bromate, iodate, chromate, dichromate, or permanganate.

17. The polymer of claim 1, or a salt thereof, wherein:
R^{1a} and R^{1b} are each independently 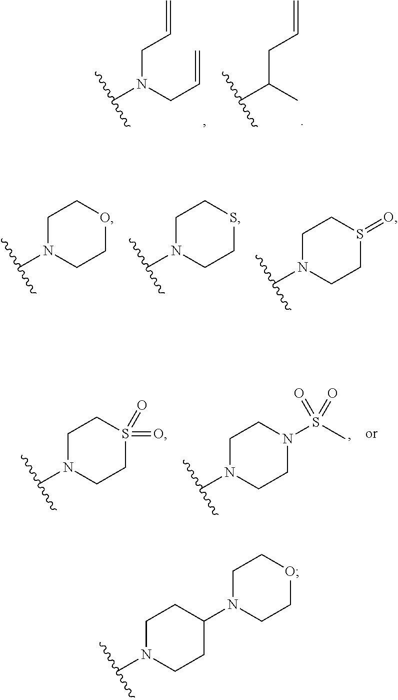
R^{2a} and R^{2b} are each hydrogen;
R³ is —CN; and
X is —N═ or —C(CN)═,
wherein when X is —C(CN)═, then R^{1a} and R^{1b} are each other than morpholine.

18. The polymer of claim 1, or a salt thereof, wherein the polymer is:

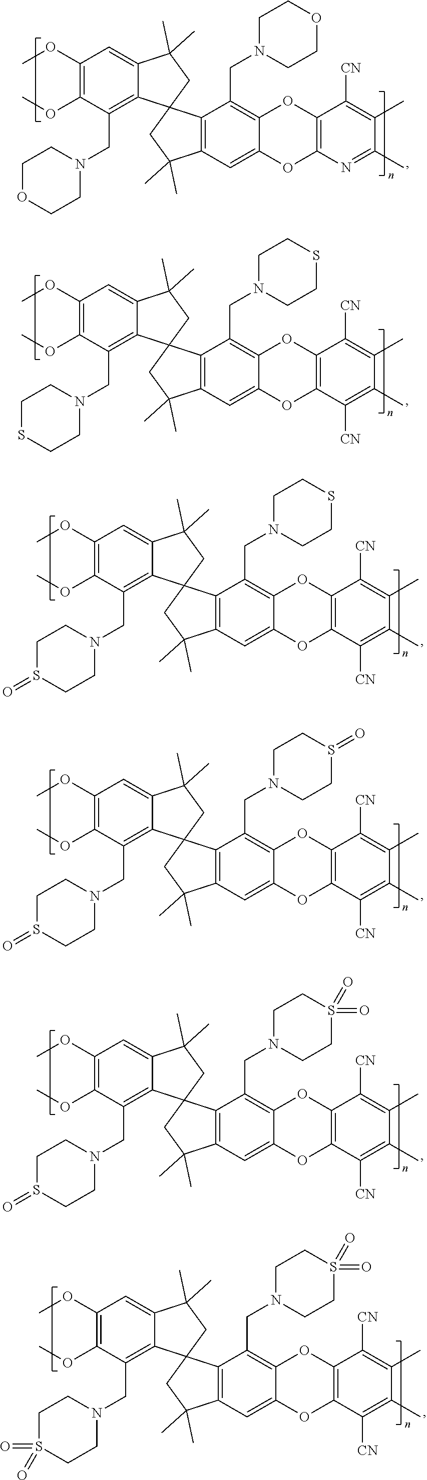

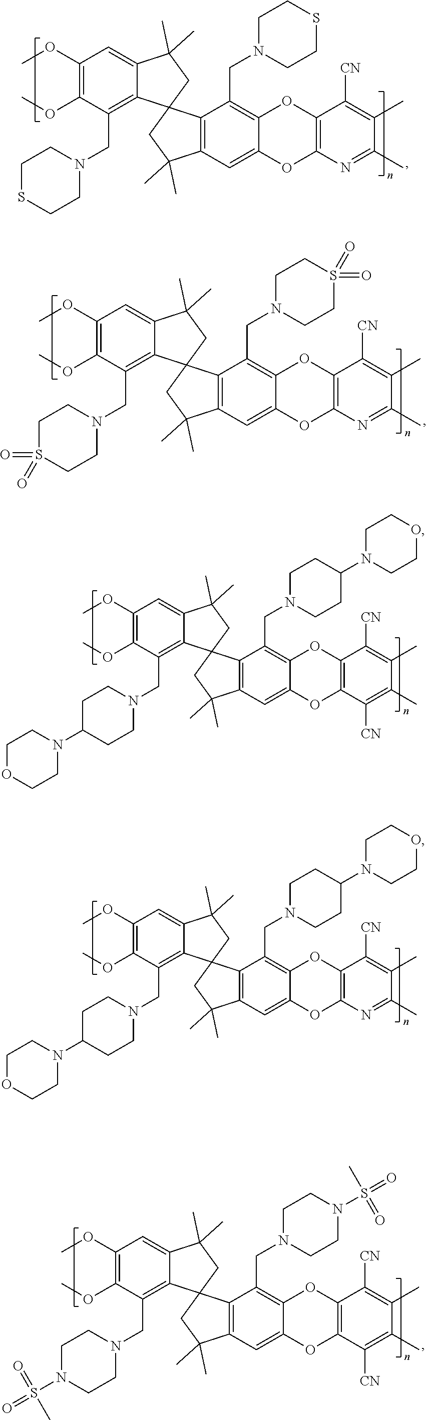

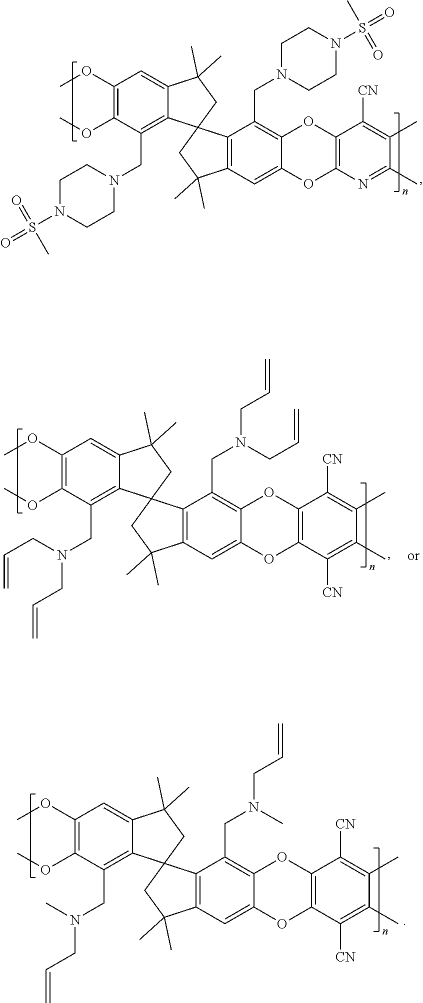

19. The polymer of claim 1, or a salt thereof, wherein the polymer is:

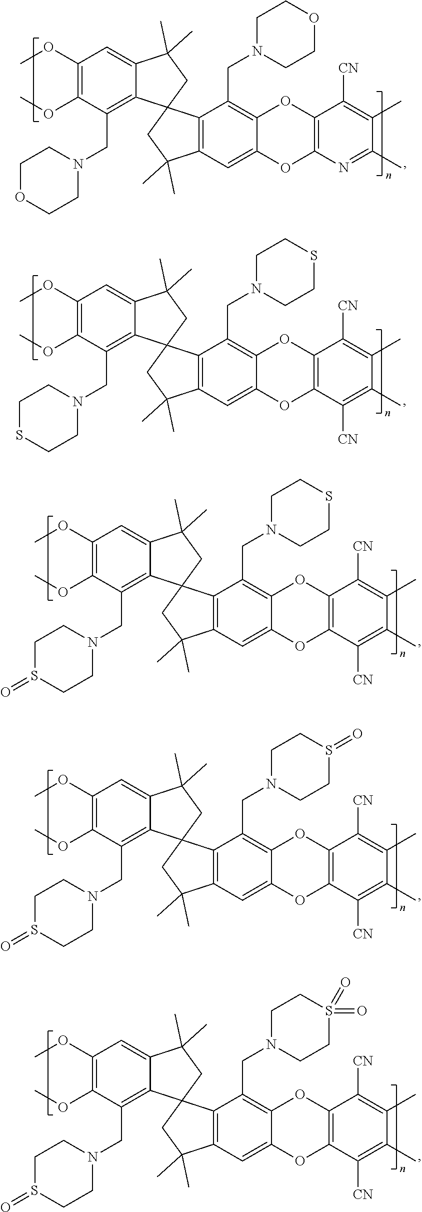

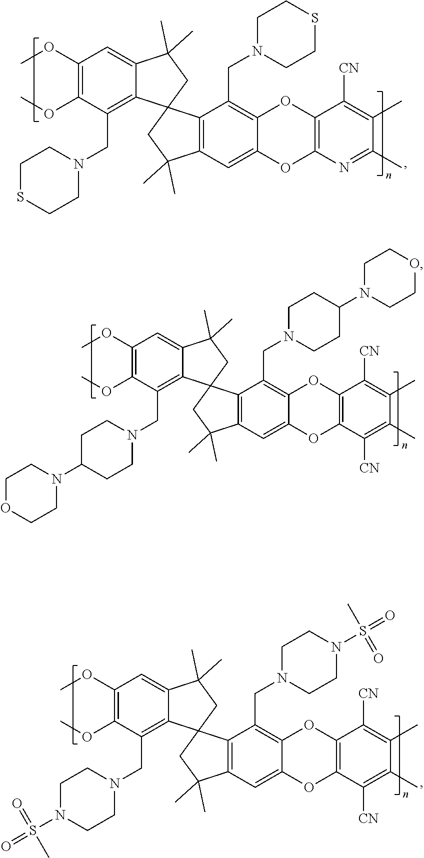

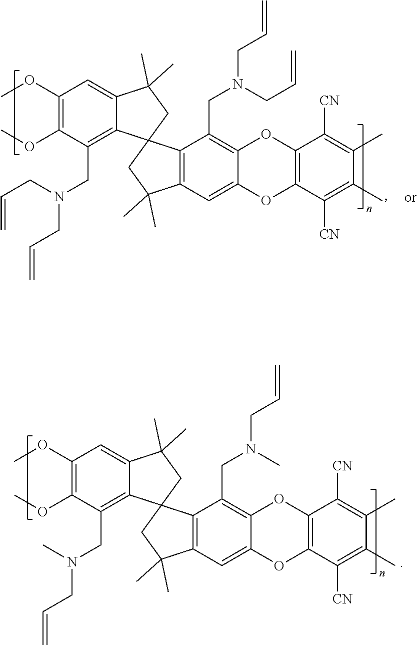

20. A compound of Formula II: 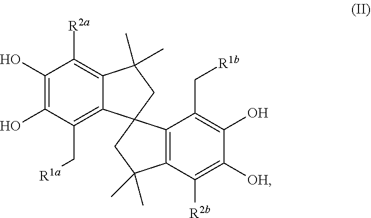
wherein:
R^{1a} and R^{1b} are each independently NR^{1a1}R^{1a2}, a 5-10 membered heterocycloalkyl having 1-4 heteroatoms each independently N, O or S, or a 5-10 membered heteroaryl having 1-4 heteroatoms each independently N, O or S, wherein the heterocycloalkyl and heteroaryl are each independently substituted with 0, 1, 2 or 3 R^{1c} groups;
each R^{1a1} and R^{1a2} is independently C₁₋₆ alkyl, C₂₋₆ alkenyl, C₂₋₆ alkynyl, or C₅₋₈ cycloalkenyl;
alternatively, R^{1a1} and R^{1a2} are combined with the atom to which they are attached to form a 5 to 8 membered heterocycloalkenyl having 0 or 1 additional heteroatoms independently N, O, or S;
each R^{1c} is independently C₁₋₆ alkyl, C₂₋₆ alkenyl, C₂₋₆ alkynyl, C₁₋₆ hydroxyalkyl, C₁₋₆ alkoxy, C₂₋₆ alkoxyalkyl, halogen, C₁₋₆ haloalkyl, C₁₋₆ haloalkoxy, ═O, ═NH, —CN, —NO₂, —C(O)H, —C(O)R^{1d}, —C(O)OR^{1d}, —S(O)₂—C₁₋₆ alkyl, —C₁₋₆ alkyl-(SO₃⁻), —O(P═O)(OR^{1d})₂, a 3-10 membered heterocycloalkyl having 1-4 heteroatoms each independently N, O or S, or a 3-10 membered heteroaryl having 1-4 heteroatoms each independently N, O or S, wherein each heterocycloalkyl and heteroaryl is independently substituted with 0, 1, 2, 3, 4, 5 or 6 R^{1e} groups;
R^{1d} is C₁₋₆ alkyl or C₁₋₆ hydroxyalkyl;
each R^{1e} is independently C₁₋₆ alkyl, C₂₋₆ alkenyl, C₂₋₆ alkynyl, C₁₋₆ hydroxyalkyl, C₁₋₆ alkoxy, C₂₋₆ alkoxyalkyl, halogen, C₁₋₆ haloalkyl, C₁₋₆ haloalkoxy, ═CH₂, ═O, —NH, —CN, or —NO₂;
R^{2a} and R^{2b} are each independently hydrogen or C₁₋₆ alkyl,
wherein when R^{2a} and R^{2b} are each hydrogen, and R^{1c} is absent, then R^{1a} and R^{1b} are other than pyrrolidine and morpholine, and
wherein when R^{2a} and R^{2b} are each hydrogen, and R^{1a} and R^{1b} are each piperazine, then R^{1c} is other than —C(O)OR^{1d}.

21. (canceled)

22. A method of making a polymer of Formula I: 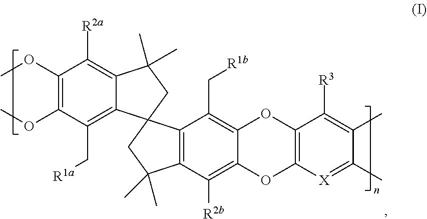
or a salt thereof, comprising:
a) forming a reaction mixture comprising a compound of Formula II: 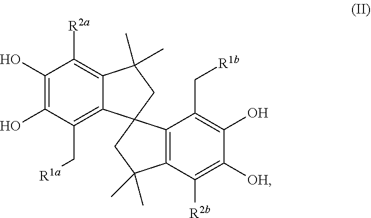
a non-nucleophilic base, a solvent, and a compound of Formula III: 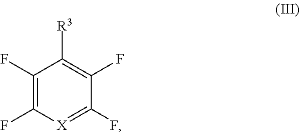
wherein the molar ratio of the compound of Formula II to the compound of Formula III is less than 1.1, under conditions suitable to form the compound of Formula I,
wherein:
R^{1a} and R^{1b} are each independently NR^{1a1}R^{1a2}, a 5-10 membered heterocycloalkyl having 1-4 heteroatoms each independently N, O or S, or a 5-10 membered heteroaryl having 1-4 heteroatoms each independently N, O or S, wherein the heterocycloalkyl and heteroaryl are each independently substituted with 0, 1, 2 or 3 R^{1c} groups;
each R^{1a1} and R^{1a2} is independently C₁₋₆ alkyl, C₂₋₆ alkenyl, C₂₋₆ alkynyl, or C₅₋₈ cycloalkenyl;
alternatively, R^{1a1} and R^{1a2} are combined with the atom to which they are attached to form a 5 to 8 membered heterocycloalkenyl having 0 or 1 additional heteroatoms independently N, O, or S;
each R^{1c} is independently C₁₋₆ alkyl, C₂₋₆ alkenyl, C₂₋₆ alkynyl, C₁₋₆ hydroxyalkyl, C₁₋₆ alkoxy, C₂₋₆ alkoxyalkyl, halogen, C₁₋₆ haloalkyl, C₁₋₆ haloalkoxy, ═O, ═NH, —CN, —NO₂, —C(O)H, —C(O)R^{1d}, —C(O)OR^{1d}, —S(O)₂—C₁₋₆ alkyl, —C₁₋₆ alkyl-(SO₃⁻), —O(P═O)(OR^{1d})₂, a 3-10 membered heterocycloalkyl having 1-4 heteroatoms each independently N, O or S, or a 3-10 membered heteroaryl having 1-4 heteroatoms each independently N, O or S, wherein each heterocycloalkyl and heteroaryl is independently substituted with 0, 1, 2, 3, 4, 5 or 6 R^{1e} groups;
R^{1d} is C₁₋₆ alkyl or C₁₋₆ hydroxyalkyl;
each R^{1e} is independently C₁₋₆ alkyl, C₂₋₆ alkenyl, C₂₋₆ alkynyl, C₁₋₆ hydroxyalkyl, C₁₋₆ alkoxy, C₂₋₆ alkoxyalkyl, halogen, C₁₋₆ haloalkyl, C₁₋₆ haloalkoxy, ═CH₂, ═O, ═NH, —CN, or —NO₂;
R^{2a} and R^{2b} are each independently hydrogen or C₁₋₆ alkyl;
R³ is hydrogen, C₁₋₆ alkyl or —CN;
X is —N═ or —C(R⁴)═;
R⁴ is hydrogen, C₁₋₆ alkyl or —CN; and
n is an integer from 10 to 1000.

23.-32. (canceled)

33. An electrochemical cell comprising
an anode;
a cathode;
a separator comprising a polymer of claim 1; and
an electrolyte.
